(19) United States
(12) Patent Application Publication
(10) Pub. No.: US 2024/0014397 A1
(43) Pub. Date: Jan. 11, 2024

(54) CHEMICAL-RESISTANT ELASTOMER BINDER FOR FLEXIBLE ELECTRONICS

(71) Applicant: The Regents of the University of California, Oakland, CA (US)

(72) Inventors: Ying Shirley Meng, San Diego, CA (US); Joseph Wang, San Diego, CA (US); Jonathan Scharf, San Diego, CA (US); Lu Yin, San Diego, CA (US)

(21) Appl. No.: 18/041,683

(22) PCT Filed: Aug. 16, 2021
(86) PCT No.: PCT/US2021/046179

§ 371 Date: Feb. 14, 2023

Related U.S. Application Data
(60) Provisional application No. 63/066,609, filed on Aug. 17, 2020.

(51) Int. Cl. H01M 4/62; H01M 10/054; H01M 4/38; H01M 4/54; H01M 10/0565

(52) U.S. Cl. CPC H01M 4/623; H01M 10/054; H01M 4/38; H01M 4/54; H01M 10/0565; H01M 2004/028

(57) ABSTRACT

Compositions, materials, methods, articles of manufacture and devices that pertain to chemical-resistant elastomer binders and flexible, printed, high-performance electrochemical systems based on said binders. The chemical-resistant, flexible elastomer binder can be used in printable, flexible high areal energy density batteries for wearable and flexible electronics and printable, flexible fuel cells. More generally, the disclosed binder material can be used in any printed electrochemical and electronic systems, e.g., supercapacitors, electrochromic cells, sensors, circuit interconnections, organic electrochemical transistors, touch screens, solar cells, etc.

### CROSS-REFERENCE TO RELATED APPLICATIONS

This patent document claims priority to and the benefits of the U.S. Provisional Patent Application No. 63/066,609, titled “HIGH-pH RESISTANT ELASTOMER BINDER FOR FLEXIBLE ELECTRONICS,” filed on Aug. 17, 2020. The entire contents of the aforementioned patent application are incorporated by reference as part of the disclosure of this patent document.

### TECHNICAL FIELD

This patent document relates to elastomer binder materials.

### BACKGROUND

Conformal electronics are a new, emerging class of electronic devices that can conform to complex non-planar and deformable surfaces, such as living tissues like skin, textiles, robotics and others. Conformal electronic devices can include electric circuits and devices formed on flexible substrates that can be applied to and conform to a variety of surface geometries.

### SUMMARY

The techniques disclosed herein can be implemented in various embodiments to achieve chemical-resistant elastomer binders and flexible, printed, high-performance electrochemical systems based on said binders.

An aspect of the disclosed embodiments relates to a chemical-resistant flexible composite for electrochemical cells that includes a plurality of particles. The composite also includes a polymer comprising fluorine, wherein the polymer is an elastomer, wherein the polymer is configured to confine the plurality of particles within a structure formed by the polymer, and wherein the polymer and the plurality of particles form an elastic polymer-particle composite.

Another aspect of the disclosed embodiments relates to a printable ink for chemical-resistant flexible electronics components that includes a matrix including an organic solvent and a polymer comprising fluorine, wherein the polymer is dissolved in the organic solvent, and wherein the polymer is an elastomer. The ink also includes a plurality of particles contained within the matrix, wherein the organic solvent is capable of vaporizing from the matrix such that the printable ink forms an elastic polymer-particle composite upon removal of at least a part of the organic solvent from the printable ink, and wherein the polymer is configured to confine the plurality of particles within the formed composite.

Yet another aspect of the disclosed embodiments relates to a chemical-resistant flexible composite for electrochemical cells that includes a plurality of particles. The composite also includes a copolymer comprising atoms of a halogen element, wherein the copolymer is an elastomer, wherein the copolymer is configured to confine the plurality of particles within a structure formed by the copolymer, and wherein the copolymer and the plurality of particles form an elastic polymer-particle composite.

An aspect of the disclosed embodiments relates to a printable ink for chemical-resistant flexible electronics components that includes a matrix including an organic solvent and a copolymer comprising a halogen chemical element in its structure, wherein the copolymer is dissolved in the organic solvent, and wherein the copolymer is an elastomer. The printable ink also includes a plurality of particles contained within the matrix. The organic solvent of the printable ink is capable of vaporizing from the matrix such that the printable ink forms an elastic polymer-particle composite upon removal of at least a part of the organic solvent from the printable ink, and wherein the copolymer is configured to confine the plurality of particles within the formed composite.

Another aspect of the disclosed embodiments relates to a flexible battery that includes a composite material, comprising: a plurality of particles; and a polymer comprising fluorine, wherein the polymer is an elastomer, wherein the polymer is configured to confine the plurality of particles within a structure formed by the polymer, and wherein the polymer and the plurality of particles form an elastic polymer-particle composite.

Yet another aspect of the disclosed embodiments relates to a flexible battery that includes an anode comprising a first layer of a first elastic composite material including a plurality of Zn particles and a first fluorine-containing polymer confining the plurality of Zn particles within the first layer. The battery also includes a cathode comprising a second layer of a second elastic composite material including a plurality of AgO particles and a second fluorine-incorporating polymer confining the plurality of AgO particles within the second layer. The battery further includes a layer of a hydrogel electrolyte disposed between the anode and the cathode.

The subject matter described in this patent document can be implemented in specific ways that provide one or more of the following features.

### BRIEF DESCRIPTION OF THE DRAWINGS

FIG. 1A illustrates a layer-by-layer printing and vacuum sealing assembly processes according to an example embodiment of the disclosed technology.

FIG. 1B illustrates structure of an AgO—Zn battery cell according to an example embodiment of the disclosed technology.

FIG. 1C illustrates several assembled cells according to an example embodiment of the disclosed technology.

FIG. 1D illustrates flexibility of printed batteries according to an example embodiment of the disclosed technology.

FIG. 1E shows a flexible E-ink display system powered by a flexible AgO—Zn battery according to an example embodiment of the disclosed technology.

FIGS. 2A-2D show example images and data plots depicting example results of morphological and electrochemical characterizations of an example embodiment of a printed battery according to the disclosed technology.

FIG. 3 shows some example microscopic 3D images of several layers of a battery according to an example embodiment of the disclosed technology.

FIG. 4 shows an example scanning electron microscopy (SEM) image and related example Energy Dispersive X-Ray Analysis (EDX) images for an anode of a battery according to an example embodiment of the disclosed technology.

FIG. 5 shows example SEM images of a printed TiO₂ separator according to an example embodiment of the technology disclosed herein.

FIG. 6 shows an example SEM image of a cathode of a battery according to an example embodiment of the disclosed technology and corresponding EDX mapping of fluorine from a binder of the cathode and Ag of the cathode.

FIG. 7 shows example SEM images of a printed cellulose separator according to the disclosed technology at different magnifications.

FIG. 8 shows example plots of conductivity of a hydrogel according to the disclosed technology with different caustic material concentrations.

FIG. 9 shows example plots for cycling a battery according to an example embodiment of the technology disclosed herein for different electrolyte concentrations.

FIGS. 10A and 10B illustrate example 3-electrode cells according to the disclosed technology that were used for cyclic voltammetry (CV) analysis.

FIG. 11 shows an example CV of a printed Ag anode current collector and an Au-sputtered carbon cathode current collector of a battery according to an example embodiment of the disclosed technology.

FIG. 12 shows example potential profiles of an anode, a cathode vs. Zn reference and a full cell according to an example embodiment of the disclosed technology within the first 5 cycles of discharging and corresponding 4 cycles of charging.

FIG. 13 shows data plots depicting example results of electrochemical performance characterization of AgO—Zn cells according to an example embodiment of the disclosed technology operated as primary batteries.

FIG. 14 shows data plots depicting example results of electrochemical performance characterization of AgO—Zn cells according to an example embodiment of the disclosed technology, when the cells were operated as rechargeable batteries.

FIG. 15 shows cycling of a battery according to an example embodiment of the disclosed technology at different capacity ranges.

FIG. 16 shows cycling of a battery according to an example embodiment of the disclosed technology at the rate of 0.5 C.

FIG. 17 illustrates cycling at the rate of 0.05 C of two 8-layer 2×2 cm² batteries according to an example embodiment of the technology disclosed herein connected in series.

FIG. 18 shows the equivalent circuits used for the cathode and anode EIS fitting.

FIG. 19 shows a Nyquist plot and an EIS fitting for a cathode according to an example embodiment during its discharging and charging, and the corresponding anode during charging and discharging.

FIG. 20 shows images, diagrams and plots depicting example results of a performance characterization of an AgO—Zn cell according to an example embodiment of the disclosed technology under various mechanical deformations.

FIG. 21 shows a voltage profile of a 1×5 cm² battery according to an example embodiment of the disclosed technology collected during 1 mA discharge while the battery was undergoing 100 cycles of 10% lengthwise stretching.

FIG. 22 shows example images and plots depicting the powering of a flexible E-ink display system by flexible AgO—Zn batteries according to an example embodiment of the technology disclosed in this patent document.

FIG. 23 shows a diagram of an example flexible E-ink display system according to the disclosed technology.

FIG. 24 shows an illustration of an example polymer-based printing fabrication of a battery according to the technology disclosed herein.

FIG. 25 shows example images of step-by-step batched fabrication of the printed AgO—Zn batteries according to the technology disclosed in this patent document.

FIG. 26 shows example results of thickness calibration of an anode and a cathode according to the disclosed technology printed using their corresponding stencils.

FIG. 27 shows example images taken during fabrication of an electrolyte gel according to an example embodiment of the disclosed technology.

FIG. 28 shows details of the pulsed discharge profile for a battery according to an example embodiment of the disclosed technology.

FIG. 29 shows example images illustrating manual bending and twisting of a battery according to an example embodiment of the technology disclosed herein.

FIG. 30 a picture of an example flexible E-ink display system powered by batteries according to the disclosed technology.

### DETAILED DESCRIPTION

The rise of flexible electronics calls for cost-effective and scalable (in their manufacturing) flexible batteries having good mechanical and electrochemical performance. Polymers that can be used in products that benefit from flexible electronics, e.g., such as batteries, fuel cells, enzymatic sensors, etc., should have both good chemical stability (e.g., under low-pH, high-pH, and/or high-salinity conditions) and a degree of mechanical flexibility and/or stretchability, and further, at the same time, should enable good electrochemical performance of the devices that incorporate such polymers. However, current flexible electronics devices often do not meet these requirements (and therefore risk premature failure) because they do not utilize materials capable of performing under the strenuous and extreme conditions the devices typically face in practical, real-world use. In particular, materials used in battery, fuel cell and/or biosensor applications can be exposed, e.g., to deleterious chemical species, high pH, and/or high temperatures. What is needed are specialized materials that can be used in flexible electronic devices and that can perform and last under such conditions.

Flexible electronics devices should possess a high degree of chemical stability. That stability can be provided using materials which are chemically stable in the range of possible device operating conditions. Furthermore, materials used, e.g., in wearable form-factor batteries to power flexible wearable electronics should enable the batteries to supply enough power and store sufficient energy for a prolonged wearable device operation. Current flexible film batteries can only hold 0.1-5 mAh/cm², which is not enough for may practical applications. Limitations on advancing such flexible film batteries or other wearable power sources for flexible wearable electronic devices require suitable materials that possess a large propensity to resist chemical or mechanical degradation while allowing for sufficient energy storage.

Disclosed herein are compositions, materials, methods, and articles of manufacture and devices that pertain to chemical-resistant elastomer binders and flexible, printed, high-performance electrochemical systems based on said binders.

According to some embodiments of the disclosed technology, a chemical-resistant flexible composite material for providing a high chemical resilience against degradation for flexible electronics includes a polymer and a plurality of particles, in which the polymer includes fluorine and is an elastomer, and which the polymer is configured to confine the plurality of particles within a structure formed by the polymer, such that the polymer and confined plurality of particles form an elastic polymer-particle composite.). In various example embodiments, the polymer can be a copolymer.

In some implementations, for example, a chemical-resistant, flexible elastomer binder according to the disclosed technology can be used in printable, flexible batteries or supercapacitors with high areal energy density for wearable and flexible electronics, printable, flexible sensors, as well as printable, flexible fuel cells, solar cells, display panels requiring special operation environment including low pH, high pH, or high salinity. More generally, the disclosed binder materials can be used in any printed electrochemical and electronic systems, e.g., supercapacitors, electrochromic cells, sensors, circuit interconnections, thin-film or organic electrochemical transistors, touch screens, solar cells, etc.

In some example embodiments, fluorine-incorporating or chlorine-incorporating elastomeric copolymers (e.g., bipolymers, terpolymers or quaterpolymers, such as FKM/FPM fluorine rubber, or tetrafluoroethylene propylene (FEPM)) according to the disclosed technology are used as a binder that immobilizes particles in an elastic polymer-particle composite after an ink or a slurry containing the fluorine-incorporating (or the chlorine-incorporating) elastomeric copolymer according to the disclosed technology mixed with particles and an organic solvent has been cured (e.g., at an elevated temperature and/or over a certain amount of time. In this patent document, the term “fluorine-incorporating polymer” is used interchangeably with the term “fluorine-containing polymer,” the term or expression “polymer comprising fluorine” or “polymer including fluorine” or the like, the term “fluoropolymer,” or the term “fluoroelastomer.” Similarly, the term “chlorine-incorporating polymer” is used interchangeably with the term “chlorine-containing polymer,” the term or expression “polymer comprising chlorine” or “polymer including chlorine” or the like, the term “chloropolymer,” or the term “chloroelastomer.”

According to some example embodiments, copolymers (e.g., bipolymers, terpolymers or quaterpolymers) according to the disclosed technology can incorporate in their structure atoms of one or more types of halogen elements such as, e.g., fluorine (F), chlorine (Cl), bromine (Br), iodine (I), astatine (At), or tennessine (Ts). In some example embodiments, copolymers can be elastomers.

For example, a polymer according to the disclosed technology can be composed of a combination of ethylene fluorinated with 0-4 fluorine atoms and/or propylene fluorinated with 0-6 fluorine atoms with a different degree of cross-linking, polymer chain length, fluorination, or chlorination. For example, the polymer according to the disclosed technology can be a Dai-El, Viton, Tecnoflon, Fluorel, or Aflas. The monomers of the copolymer or terpolymer according to the disclosed technology can be any of: ethylene, vinylidene fluoride, tetrafluoro propylene, tetrafluoroethylene, hexafluoropropylene, ethylene tetrafluoroethylene, chlorotrifluoroethylene, perfluoro alkoxy alkane, or perfluoromethylvinylether. The polymer can be dissolved in organic solvents and mixed with various types of materials to form flexible high-pH, low-pH, or high salinity resistant composite (e.g., after the solvent has been evaporated at an elevated temperature). When mixed with particles such as, e.g., graphite, carbon black, zinc, silver, copper, bismuth, oxides of metals such as zinc oxide, silver (I) oxide, silver (I, III) oxide, bismuth (III) oxide, lead (II) oxide, titanium (IV) oxide, other solid organic material powders such as cellulose, methylcellulose, sucrose, or polymers such as polyvinyl alcohol, polyacrylic acid, polyethylene oxide, etc., the dissolved polymer and the particles form a printable or casting-compatible ink or slurry. After removing the solvent at, e.g., an elevated temperature (e.g., the one above 30 degrees Celsius), the resultant composite material is mechanically self-supporting (e.g., capable of maintaining its mechanical structure on its own), soft, flexible, stretchable, and porous. The printed/cast composite can be used as a sealant, encapsulation, current collectors, electrodes, electrode surface coating, separators, or a part of an electrolyte.

Devices fabricated with a composite material according to the technology disclosed in this patent document can be electrochemically active yet chemically stable without self-degradation. An electrode printed using an ink or a slurry containing a binder according to the disclosed technology can hold low impedance and can be very thick without affecting its electrochemical or electrical performance (e.g., after the ink or the slurry has been cured). The flexible composite materials according to the disclosed technology also offer a certain amount of mechanical resilience against bending, twisting, and stretching deformations. For example, flexible electronics produced using materials and techniques according to the disclosed technology (e.g., deposited as composites with elastomeric materials as binders, according to the disclosed technology) can be wrapped or be bent and can be shaped to fit to, e.g., curvilinear surfaces. For various conformal electrochemical systems, chemical stability of the materials according to the disclosed technology ensures device robustness and durability.

In some example embodiments according to the disclosed technology, a chemically-stable fluoroelastomer according to the disclosed technology can be dissolved, e.g., in a low molecular weight ketone (e.g. acetone, methyl ethyl ketone, methyl propyl ketone, methyl butyl ketone, methyl isobutyl ketone, acetophenone, benzophenone), and/or a low molecular weight ester (e.g., methyl formate, methyl acetate, ethyl acetate, ethyl propionate, isopropyl butyrate, and ethylbenzoate) and mixed with carbonaceous powder (e.g., graphite, carbon black, activated carbon, graphene, carbon nanotubes), metal powder in a form of, e.g., microparticles, nanoparticles, nanowires, nanorods or flakes (e.g., platinum, gold, silver, zinc, nickel, tin, iron, manganese, magnesium, aluminum, copper, bismuth, indium, lithium, sodium), metal oxides (e.g., zinc oxide, silver (I) oxide, silver (I,III) oxide, manganese (II) oxide, manganese (IV) oxide, bismuth (III) oxide, lead(II) oxide, lead (II, IV) oxide, titanium (IV) oxide, vanadium (III) oxide, vanadium (IV) oxide, vanadium (V) oxide, lithium (I) oxide, magnesium oxide, copper (I) oxide, copper (II) oxide, indium (III) oxide, tin (II) oxide, tin (IV) oxide, lead (II) oxide, iron (II) oxide, iron (III) oxide), metal salts (fluorides, chlorides, bromides, iodides, acetates, nitrates, sulfates, carbonates persulfates, permanganates, hydroxides, oxyhydroxides, sulfonates), saccharides and their derivatives (e.g., glucose, sucrose, cellulose, maltodextrin methylcellulose, ethylcellulose, hydroxypropyl methylcellulose, carboxymethyl cellulose), surfactants (e.g., sodium dodecyl sulfate, dodecyl benzene sodium sulfonate, Triton-X 100, Triton-X 114, Zonyl fluorosurfactants, Span 80, perfluorooctanesulfonate) or other polymers (e.g., polyvinyl alcohol, polyacrylic acid, polyethylene oxide, polystyrene, polystyrene sulfonate, polymethacrylate, polystyrene block copolymers, polyethylene vinyl acetate, polyurethane, polyvinylidene fluoride, tetrafluoro ethylene, polyvinylpyrrolidone, polypropylene oxide) to form a polymer-particle (or polymer-powder) composite ink or slurry according to the disclosed technology. The ink can be deposited onto various substrates via different printing techniques as electrodes, separators, or part of an electrolyte, for example. The printed elements (e.g., electrodes) can be thereafter assembled into electrochemical cells for use in low-pH, high-pH, or high-salinity conditions.

In some example embodiments, the fluorine-containing or chlorine-containing polymer according to the disclosed technology can be dissolved in methyl isobutyl ketone (MIBK) and mixed with silver (I, III) oxide and carbon black to form a cathode ink, with zinc and bismuth oxide to form an anode ink, with titanium oxide and cellulose powder to form a separator ink, and with graphite and carbon black to form a conductive current collector ink. The inks can be printed layer-by-layer to form a silver-zinc battery according to the disclosed technology that can work with a high-pH electrolyte (e.g., the one with pH>10 or pH>14). The printed silver-zinc battery according to the disclosed technology is stable at such high pH and provides high areal capacity (e.g., >50 mAh/cm²) with low cell impedance for high current discharges.

According to various example embodiments, a polymer binder according to the disclosed technology can be used in printable, flexible high areal energy density batteries for wearable and flexible electronics. An elastomer polymer binder according to the disclosed technology can also be used in printable, flexible fuel cells that require special operating environments (e.g., low pH, high pH, or high salinity). The polymer can be also used in any printed electrochemical and/or electronic systems, such as sensors, batteries, supercapacitors, fuel cells, electrochromic cells, circuit interconnections, thin-film or organic electrochemical transistors, touch screens, solar cells, etc.

The ink or slurry formulated according to the disclosed technology can be deposited

on a substrate by various production processes, such as inkjet printing, screen-printing, stencil printing, dip coating, spray coating, drop casting, 3D printing, injection molding, stamping, transfer printing, water transfer printing, etc. The substrate can include a flexible polymer, a stretchable elastomer, various textiles, glasses, ceramics, metal, etc. The substrate can be structured, for example, in flat sheets or various curved surfaces. The ink or slurry deposited on the substrate can be cured, for example, by exposing it to an elevated temperature, or enhanced ventilation to remove excess solvent from it. The ink or the slurry can be also illuminated with ultraviolet or visible light or interacted with a peroxide or bisphenol curing agent. The thickness of the ink/slurry deposition can be controlled by controlling, for example, the time of deposition, viscosity of the ink or slurry, dilution of the ink or slurry, inclusion of additives, or thickness of stencils. Repeated deposition after curing can be implemented to deposit the composite material layer-by-layer, to obtain high areal loading for high areal capacity or high surface area. A calibration curve for an individual ink formulation according to the technology disclosed herein that determines thickness of a resulting deposited material layer can be established based on the deposition methods, deposition variables, and the number of deposition repetitions or cycles.

Non-limiting example embodiments and implementations of the chemical-resistant, flexible elastomer binder compositions, material products, methods and devices incorporating such therein are disclosed in this patent document. In particular, some examples of the disclosed technology are embodied in the following examples of a high-performance printed AgO—Zn rechargeable battery for flexible electronics.

In the following example implementations, example embodiments of printable, polymer-based AgO—Zn batteries are described that feature flexibility, rechargeability, high areal capacity, and low impedance. Using elastomeric substrate and binders according to the technology disclosed herein, the current collectors, electrodes, and separators can be printed (e.g., screen-printed) layer-by-layer and vacuum-sealed in a stacked configuration. The batteries according to the disclosed technology are customizable in sizes and capacities, with areal capacities as high as 54 mAh/cm² for primary applications. The batteries were used, for example, to power a flexible E-ink display system that requires a high-current drain, and exhibited superior performance compared to commercial coin-cell batteries. Advanced micro computed tomography (micro-CT) and electrochemical impedance spectroscopy (EIS) were used to characterize a battery according to an example embodiment of the disclosed technology, whose mechanical stability was tested with repeated twisting and bending. The disclosed AgO—Zn batteries present a practical solution for powering a wide range of electronics and hold major implications for the future development of practical and high-performance flexible batteries.

Recent interest in multifunctional flexible electronics for applications in sensing, displays, and wireless communication advocates for the development of complementary flexible energy storage solutions. Despite the exponential growth in the wearable flexible electronics market, a need still exists for scalable, low-cost, and high-performance flexible battery technologies to provide practical energy storage solutions for the tens of millions of devices produced every year. Many existing flexible batteries rely on fabrication processes that are complex, low throughput, and high cost, and thus have limited practicality which hinders their lab-to-market transformation. Printed high-performance batteries according to the disclosed technology address the need for flexibility and scalability while maintaining low cost. Using low-cost thick-film fabrication technologies, flexible battery components according to the disclosed technology can be printed sheet-to-sheet or roll-to-roll using traditional, low-maintenance screen printing or doctor blade casting equipment, for example, thus realizing low-cost mass production of flexible batteries.

Among commercialized printed flexible batteries, aqueous zinc (Zn)-based conversion cells were successful in developing products with high throughput and low production cost. The Zn anode chemistry has been of special interest for the flexible battery market due to its low material cost, high theoretical capacity (820 mAh/g, 5854 mAh/L), good rechargeability, and safe chemistry. In addition, as Zn and the aqueous electrolyte can be readily handled in ambient environment, the equipment and production costs of Zn-based batteries are often considerably lower compared to lithium-ion batteries. However, commercial Zn-based printed flexible batteries are usually non-rechargeable and feature low capacity and high impedance, thus limiting their applications to low-power, disposable electronics only. Silver oxide-zinc (Ag₂O—Zn) batteries have a rechargeable chemistry and can tolerate a high-current discharge. The redox reaction in such batteries relies on the dissolution of zinc ions (Zn²⁺) and silver ions (Ag⁺) in the alkaline electrolyte and their supersaturation-induced precipitation, which takes place rapidly while maintaining a stable voltage at 1.56 V, as shown in Equations 1-6.

### Anode:

(Dissolution) Zn(s)+4OH⁻(aq)⇄Zn(OH)₄²⁻(aq)+2e⁻ (1)

(Relaxation) Zn(OH)₄²⁻(aq)⇄ZnO(s)+H₂O+2OH⁻(aq) (2)

(Overall) Zn(s)+2OH⁻(aq)⇄ZnO+H₂O+2e⁻E°=−1.22V vs. SHE (3)

### Cathode:

(Dissolution) Ag+OH⁻⇄AgOH(aq)+e⁻ (4)

(Relaxation) 2AgOH(aq)⇄Ag₂O(s)+H₂O (5)

(Overall) Ag₂O(s)+H₂O⇄2Ag(s)+2OH⁻(aq) E°=+0.34 V vs. SHE (6)

Most of these batteries rely solely on the use of the lower oxidation state of silver to obtain reversible redox reaction, while the higher oxidation state (AgO), with its redox reaction described in Equation 7, has been rarely utilized.

2AgO(s)+H₂O+2e⁻⇄Ag₂O(s)+H₂O(l) E°=+0.60 V vs. SHE (7)

The previous underutilization of AgO can be attributed to its instability, namely, its lattice phase change when transitioning into Ag₂O, which may result in irreversible shape changes that impede rechargeability, and its high charging potential responsible of possible electrode gassing due to oxygen evolution reaction. However, once these issues are addressed, it is possible to access a much higher theoretical cathode capacity (from 231 mAh/g for Ag₂O to 432 mAh/g for AgO). So far, printed silver-zinc batteries reported in the literature still have low rechargeability (e.g., <50 cycles), limited capacity (e.g., <12 mAh/cm² for primary cell, <3 mAh/cm² for secondary cell), along with high internal resistance (e.g., ˜10²Ω) that results in a large voltage drop during operation. Such limitations are hindering the adaptation of silver-zinc printed batteries in flexible electronics.

Herein, as shown by example embodiments and implementations, a new material and fabrication process for all-printed, flexible, and rechargeable AgO—Zn batteries with ultra-high areal capacity, low impedance, and good rechargeability as a practical energy storage solution for flexible electronics is presented.

The fabrication of a battery cell according to the disclosed technology relies on low-cost, high-throughput, layer-by-layer printing of formulated powder-elastomer (or particle-elastomer) composite inks according to the disclosed technology to form the current collectors, Zn anode, AgO cathode, and their corresponding separators. The battery adopts a low-footprint stacked configuration, with potassium hydroxide (KOH)-poly(vinyl alcohol) (PVA) hydrogel as a low impedance electrolyte sandwiched between the two fully printed electrodes. Using the thermoplastic styrene-ethyl-butylene-styrene block copolymer (SEBS) elastomer-based substrate, the assembled battery can be directly heat- and vacuum-sealed to preserve the electrolyte and ensure appropriate cell pressure during operation. This fabrication and assembly process can be applied to different cell sizes with adjustable areal capacity, allowing customizable battery form factors that are tailored for specific applications. Fully utilizing the higher oxidation state of the AgO, example as-printed cells according to the disclosed technology were able to reach a high areal capacity of >54 mAh/cm² while maintaining a low internal resistance (e.g., ˜10Ω) for primary applications. Furthermore, utilizing an optimized cycling profile according to the disclosed technology, the printed cells were recharged for over 80 cycles, sustaining 0.2 C-1 C discharges without exhibiting significant capacity loss, while maintaining low impedance throughout each cycle. Moreover, the fabricated cells according to the disclosed technology displayed outstanding robustness against repeated bending and twisting deformations. To demonstrate their performance in powering typical flexible electronics, the fabricated thin-film batteries according to the technology disclosed herein were successfully implemented in a flexible E-ink display system with an integrated microcontroller unit (MCU) and Bluetooth (BT) modules that require pulsed high-current discharges. Leveraging low-cost scalable production process, polymer-based flexible architecture, and customized ink formulations, the all-printed AgO—Zn battery according to the disclosed technology, with its desirable mechanical and electrochemical performance, presents a practical solution for powering the next-generation flexible electronics, and sets a new benchmark for the further development of printable flexible batteries.

An example all-printed fabrication method of the flexible AgO—Zn battery according to the disclosed technology was designed based on the careful selection of elastomers for the substrate, sealing, and ink binders based on their mechanical properties, chemical stabilities, and processabilities. SEBS was selected as the substrate material for its good solvent processability, chemical stability under high pH, outstanding elasticity, as well as its appropriate melting point (˜200° C.), allowing it to be easily cast into films that are chemically stable, flexible, and heat-sealable to support and seal the battery. Screen-printing, a low-cost high-throughput thick-film technique was used for ink deposition, as it allows the efficient fabrication of the current collectors, electrodes, and separators into their preferred shapes and thicknesses. The screen-printing of the batteries according to an example embodiment of the disclosed technology relies on the customized formulation of 6 inks corresponding to the current collectors, electrodes, and the separators for both the anode and cathode. Conductive and flexible silver ink and carbon ink were printed as the anode and cathode current collectors, respectively. Both inks use SEBS as the elastomer binder and toluene as the solvent to allow the ink to firmly bond to the toluene-soluble SEBS substrate. The anode ink was composed of Zn particles with bismuth oxide (Bi₂O₃) as an additive to reduce dendrite formation and suppress H₂ gassing, while the cathode ink was mainly composed of AgO powder with a small amount of lead oxide coating to enhance the electrochemical stability and carbon black added to enhance the electronic conductivity of the electrode. A chemically stable (e.g., high-pH, low-pH, and/or high-salinity stable), elastomeric fluorocopolymer was used as the binder for both electrodes for its solubility in lower ketones which is less prone to oxidation by the highly oxidative AgO. Cellulose powder was used to form the porous cathode separator to capture and reduce dissolved silver ions and prevent material crossover. In some embodiments, the cathode separator can be made of cellophane. A titanium dioxide (TiO₂)-based ink was formulated for the anode separator, acting as a physical barrier to Zn dendrite growth. Lastly, a solid-phase polyvinyl alcohol (PVA) hydrogel crosslinked with potassium hydroxide (KOH) was prepared as the electrolyte, which complements the cell flexibility without the risk of leaking. Lithium hydroxide (LiOH) and calcium hydroxide (Ca(OH)₂) were used as additives in the electrolyte to maintain electrolyte chemical stability and minimize zinc dissolution.

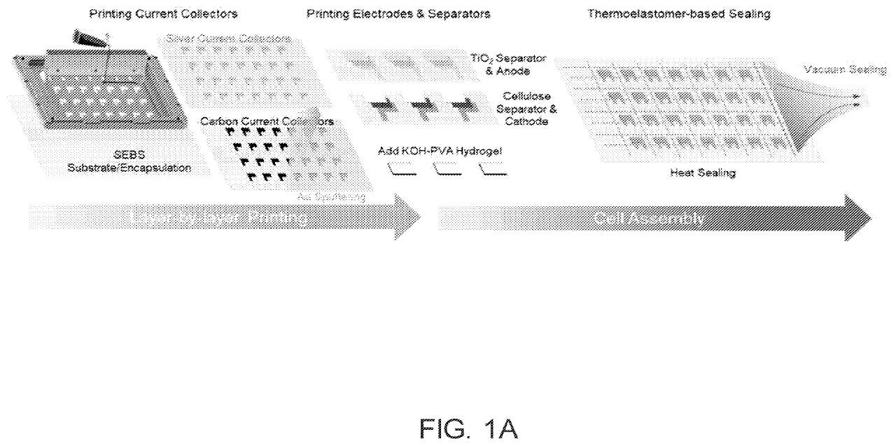

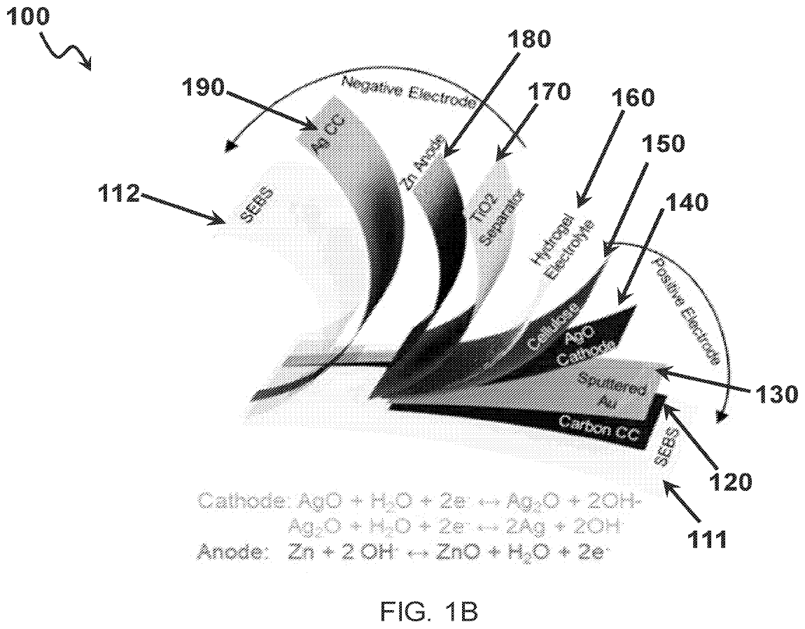

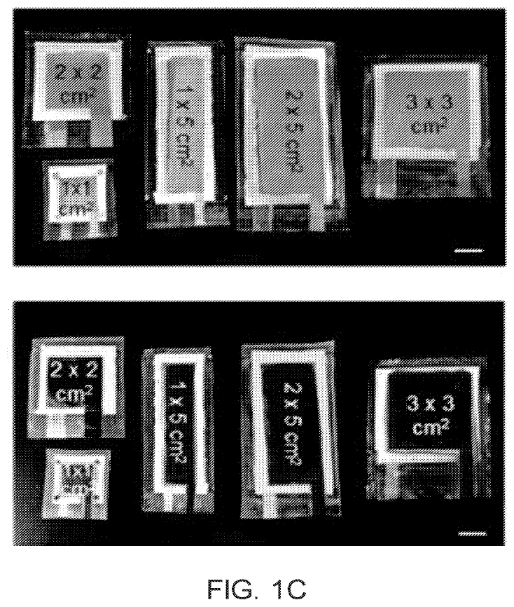

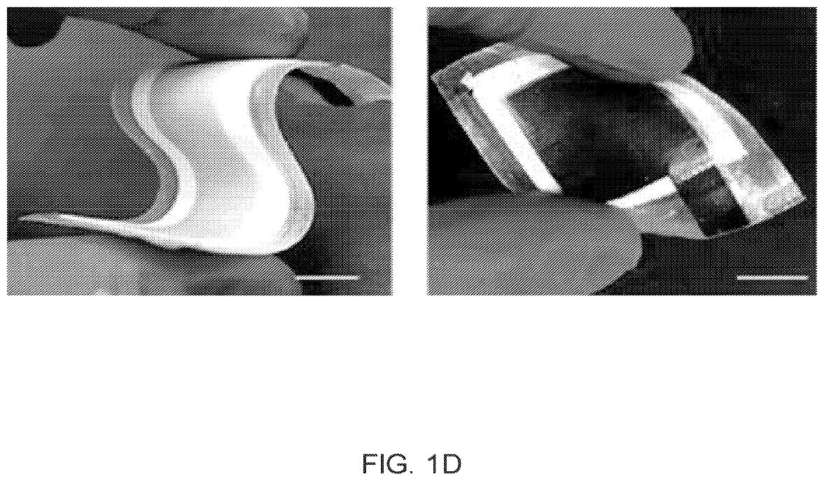

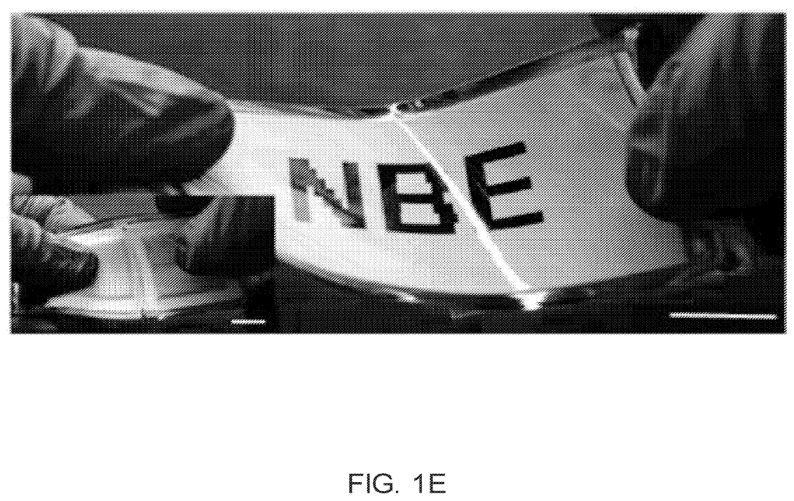

FIG. 1A illustrates a layer-by-layer printing and vacuum sealing assembly processes according to an example embodiment of the disclosed technology. The fabrication of the batteries according to an example embodiment of the technology disclosed herein begins with the preparation of the substrates, where a resin of SEBS dissolved in toluene was cast onto wax papers using film casters and dried in an oven to form a transparent elastic film. Firstly, the Ag and the carbon inks were printed onto the SEBS substrate as current collectors, with a 400 nm layer of gold sputtered onto the carbon current collectors to enhance their conductivity and chemical stability. Then, the Zn and the TiO₂ inks, and the AgO and the cellulose inks were printed onto their corresponding current collectors. To complete the cells, the KOH-PVA hydrogel electrolyte was cut to size and sandwiched between the two electrodes. Lastly, the sheet of batteries was heat and vacuum sealed and separated into individual cells, finalizing the scalable sheet-by-sheet fabrication of multiple cells in one sitting.

FIG. 1B illustrates structure of an AgO—Zn battery cell 100 according to an example embodiment of the disclosed technology. The cell 100 is composed of a hydrogel electrolyte sandwiched between the 2 electrodes, with each side composed of a heat-sealable SEBS substrate, current collectors, active material electrodes, and corresponding separators. The cell 100 includes the following layers: SEBS substrate 111, carbon current collector (CC) 120, a layer of gold (Au) 130 sputtered onto the CC 120, AgO cathode 140, a cellulose-based separator 150, hydrogel electrolyte 160, TiO₂ separator 170, Zn anode 180, Ag current collector 190, and SEBS substrate 112. The flexible, vacuum-sealed AgO—Zn batteries according to an example embodiment of the disclosed technology, comprised of 9 layers of composite materials, can thus be easily fabricated using layer-by-layer screen-printing (e.g., FIG. 1A). The major advantage of the stencil printing technique is the customizable dimension of the cells that can be tailored for different applications with specific form factor and capacity requirements.

FIG. 1C illustrates several assembled cells according to an example embodiment of the disclosed technology in different customized sizes. As examples, cells in different sizes, as shown in FIG. 1C, were fabricated using the same fabrication process as for the cell shown in FIG. 1B and can be integrated with flexible electronic devices having different sizes.

FIG. 1D illustrates flexibility of printed batteries according to an example embodiment of the disclosed technology. Regardless of the shapes and sizes, the assembled cells are highly flexible and durable under repeated mechanical deformations (FIG. 1D), making them highly suitable for powering wearable and flexible electronics that require high resiliency to various deformations.

FIG. 1E shows a flexible E-ink display system powered by a flexible AgO—Zn battery according to an example embodiment of the disclosed technology. The superior electrochemical performance of AgO—Zn batteries fabricated according to the technology disclosed herein greatly expands the application of thin-film batteries in electronics with high power demands. This capability was demonstrated by powering a flexible display system with microcontroller and Bluetooth modules (FIG. 1E). Scale bar in FIGS. 1C-1E is 1 cm.

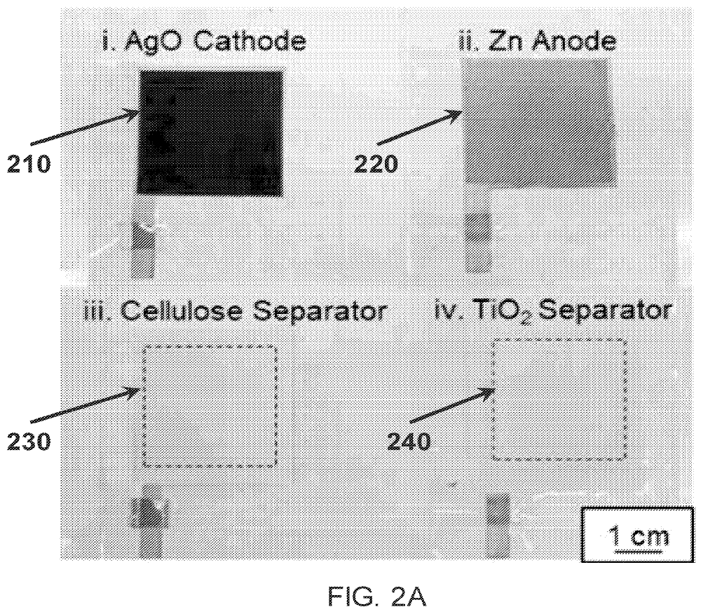

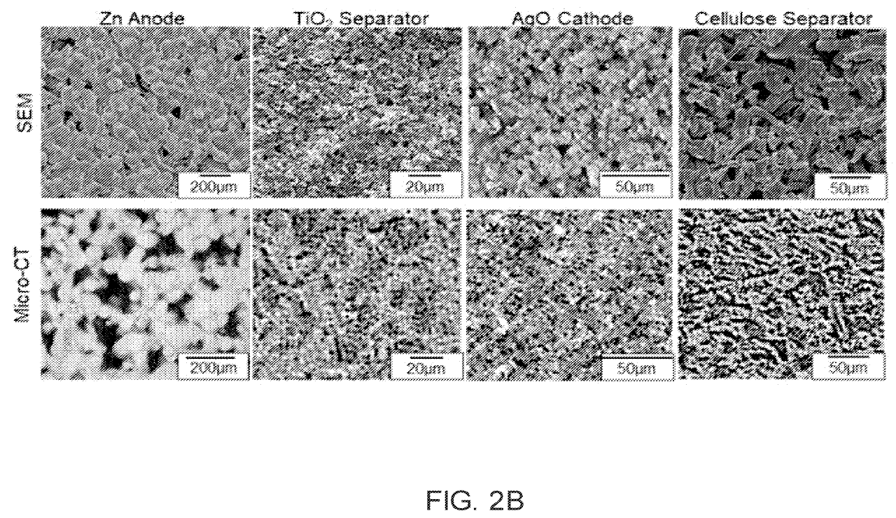

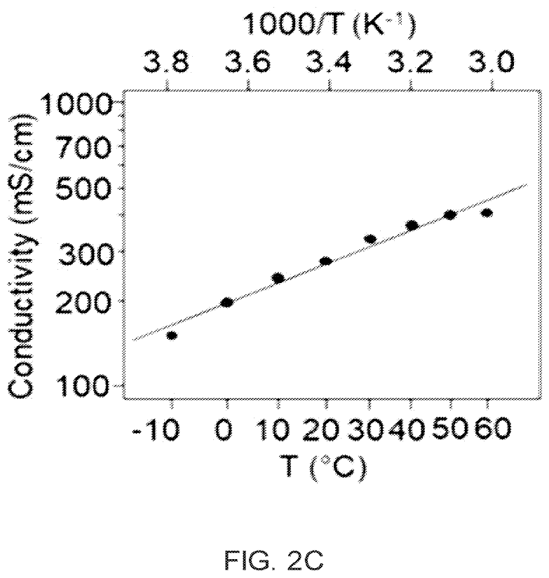

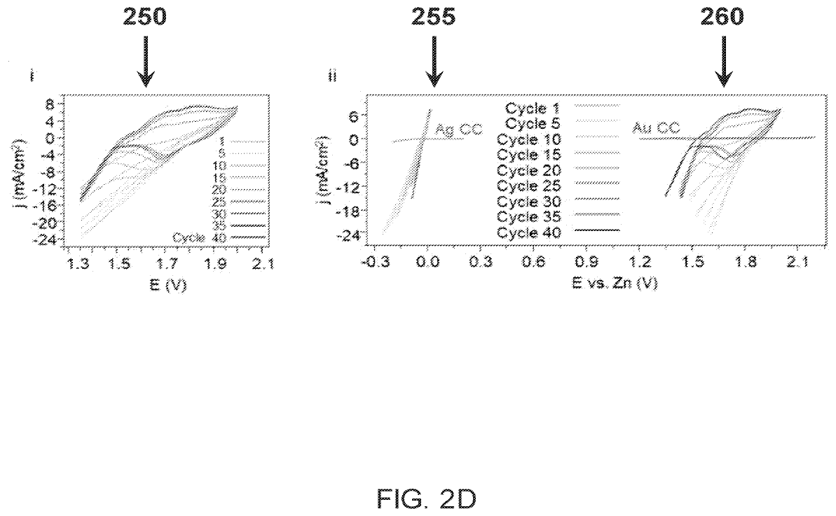

FIGS. 2A-2D show example images and data plots depicting example results of morphological and electrochemical characterizations of an example embodiment of a printed battery according to the disclosed technology. FIG. 2A shows example images of electrodes and separators of a printed 3×3 cm²

cell according to the disclosed technology: the (i) AgO electrode (cathode) 210, (ii) Zn electrode (anode) 220, (iii) cellulose separator 230, and (iv) TiO₂ separator 240.

FIG. 2B shows microscopic images of corresponding layers of the cell taken via SEM (top row in FIG. 2B) and Micro-CT (bottom row in FIG. 2B).

FIG. 2C shows an example data plot showing the conductivity of the gel electrolyte as a function of temperature.

FIG. 2D shows example data plots showing 40 cycles of cyclic voltammetry (CV) between 2 V and 1.35 V of the full cell (plot 250) and corresponding potential shifts in the anode (plot 255) and the cathode (plot 260) using a 3-electrode cell with a Zn metal pseudo-reference electrode. The CVs of the current collectors within the corresponding voltage windows (anode −0.3 V-0.3 V, cathode 1.2 V-2.2 V) under the electrolyte environment are overlaid onto the electrode CVs. Scan rate: 10 mV/s.

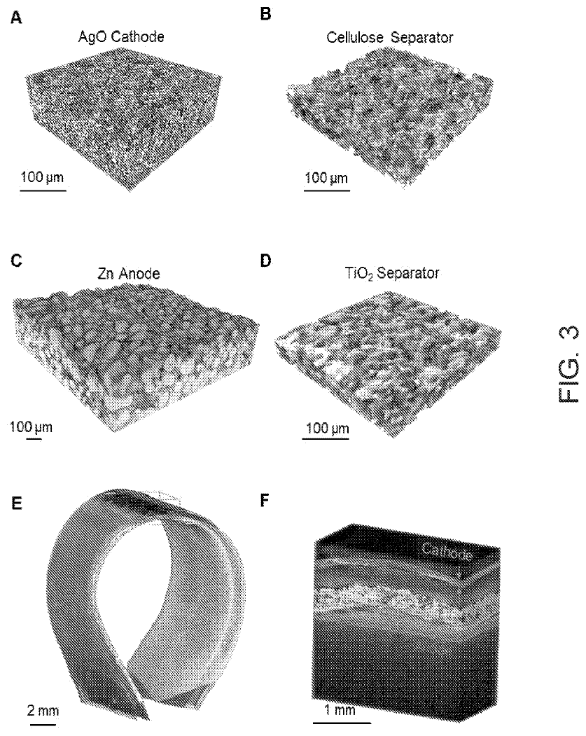

The printed electrodes and separators (FIG. 2A) were characterized by scanning electron microscopy (SEM), as well as non-intrusive, in-situ micrometer-scale X-ray computed tomography (micro-CT). Micro-CT enables the capability of non-destructive inspection of the battery, which can be highly beneficial to characterize it under deformation without the need to disassemble the battery cells. The micro-CT images in FIG. 2B show a morphology which is in agreement with the SEM images of the pristine anode, cathode, cellulose separator, and TiO₂ separator. 3-dimensional (3D) imaging of these films is shown in FIG. 3 which gives a more comprehensive understanding of the material structures.

FIG. 3 shows some example microscopic 3D images of the cathode (panel A), cellulose separator (panel B), anode (panel C), and TiO2 separator (panel D) generated using the micro-CT. Panel (E) in FIG. 3 shows a 3D image of a bent 1×5 cm² battery according to an example embodiment of the disclosed technology in a different angle and panel (F) in FIG. 3 shows an example zoomed-in view of the top of the battery showing no cracking and no delamination between the layers of the battery.

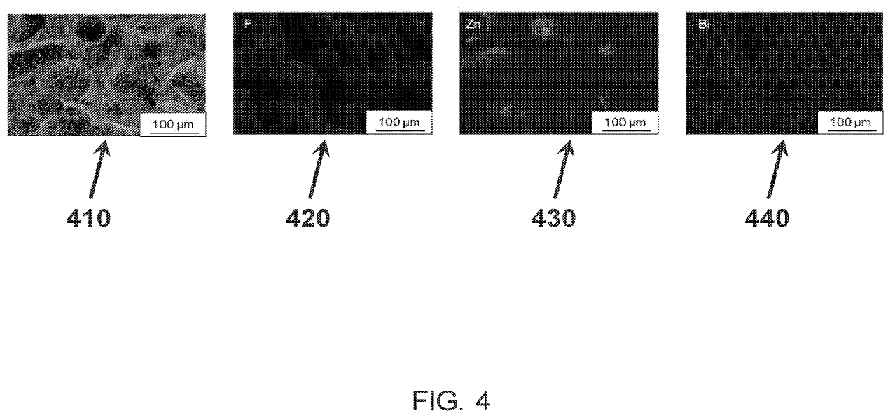

The loosely packed Zn anode according to some example embodiments of the disclosed technology includes large particles, with sizes in the range of 50 μm to 100 μm, which can reduce the surface passivation induced by the spontaneous reaction with the electrolyte. Energy Dispersive X-Ray Analysis (EDX) further shows the homogeneous coverage of the Bi₂O₃ and the fluoropolymer binders on the surfaces of the Zn particles (FIG. 4).

FIG. 4 shows a SEM image of an example embodiment of a composite material according to the disclosed technology, implemented in an example anode of a battery according to an example embodiment of the technology disclosed herein (image 410). The composite material shown in the image 410 in FIG. 4 includes a plurality of Zn particles and a polymer comprising fluorine that acts as a binder and is configured to confine the plurality of Zn particles within a structure formed by the polymer. In some embodiments of the composite material, particles of the composite material include a coating layer of a coating material covering (e.g., at least partially) an outer surface of the particles. For example, in the specific example embodiment of the composite material shown in the image 410 (FIG. 4), Zn particles are covered by a layer of Bi₂O₃ powder (a powder can include, e.g., particles of a size between 0.1 nm and 100 micrometers). FIG. 4 further shows example images of EDX mapping, corresponding to the SEM image 410, of fluorine from the binder (the polymer comprising fluorine) of the composite material (image 420), as well as Zn particles (image 430), and bismuth of the bismuth oxide coating layer of the Zn particles (image 440) of the composite material.

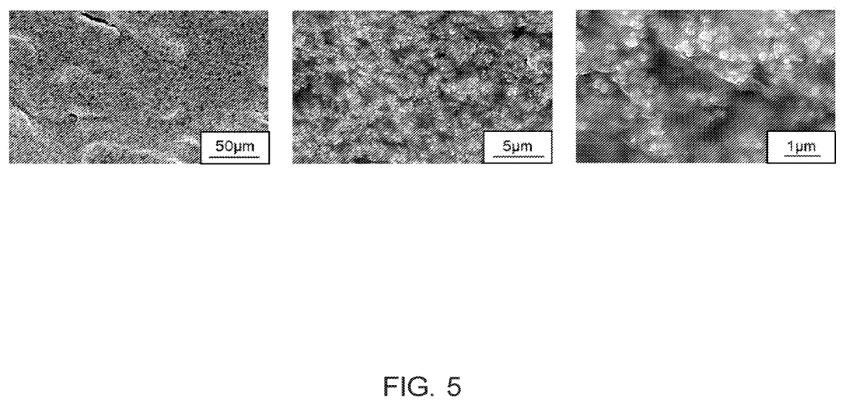

FIG. 5 shows example SEM images, with different magnifications, of a printed TiO₂ separator according to an example embodiment of the technology disclosed herein. The TiO₂ separator of a battery according to some example embodiments of the disclosed technology contains much smaller particles compared to the particles of the batterie's Zn anode to form a dense and homogenous film, and thus can effectively reduce the dendrite growth (FIG. 5).

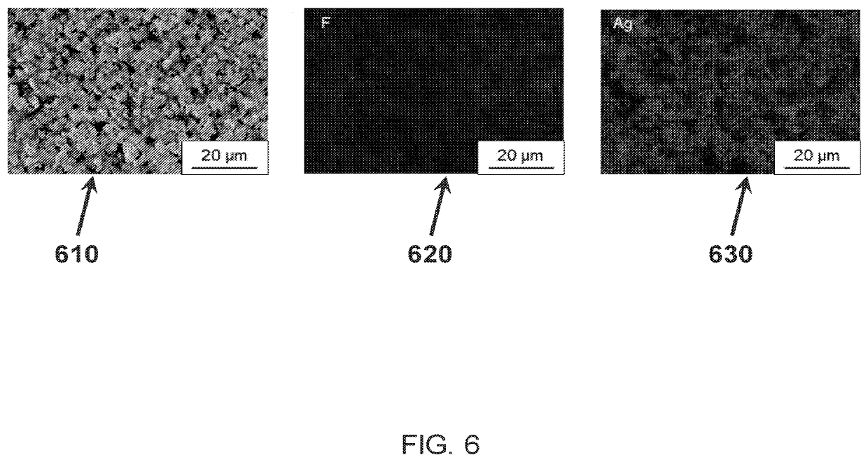

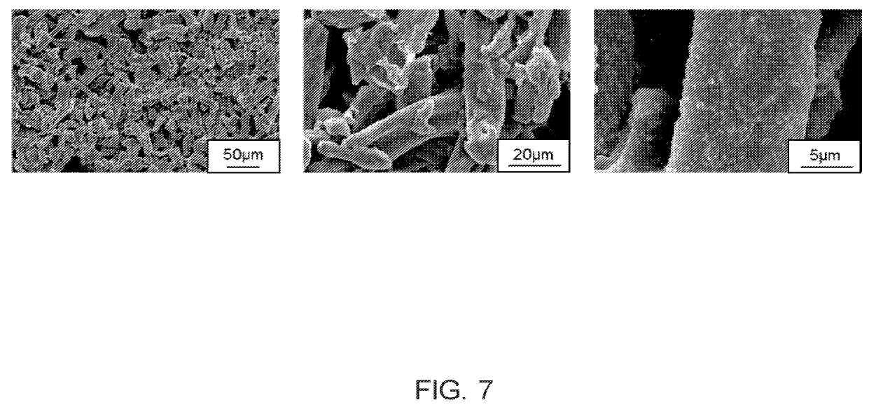

In comparison, for example, the AgO electrode (cathode) uses 1-20 μm particles to produce a porous electrode, which was paired with a separator with similar particle sizes to capture the dissolved Ag species (FIG. 6 and FIG. 7, respectively).

FIG. 6 shows an example SEM image 610 of an example embodiment of a composite material according to the disclosed technology, implemented in an example cathode of a battery according to an example embodiment of the technology disclosed herein. The composite material shown in the image 610 (FIG. 6) includes a plurality of AgO particles and a polymer comprising fluorine that acts as a binder and is configured to confine the plurality of AgO particles within a structure formed by the polymer. FIG. 6 further shows images of EDX mapping, corresponding to the SEM image 610, of fluorine (image 620) from the binder (the polymer comprising fluorine) of the cathode and Ag (image 630) of the AgO particles of the cathode.

FIG. 7 shows example SEM images of a printed cellulose separator for the cathode electrode at different magnifications.

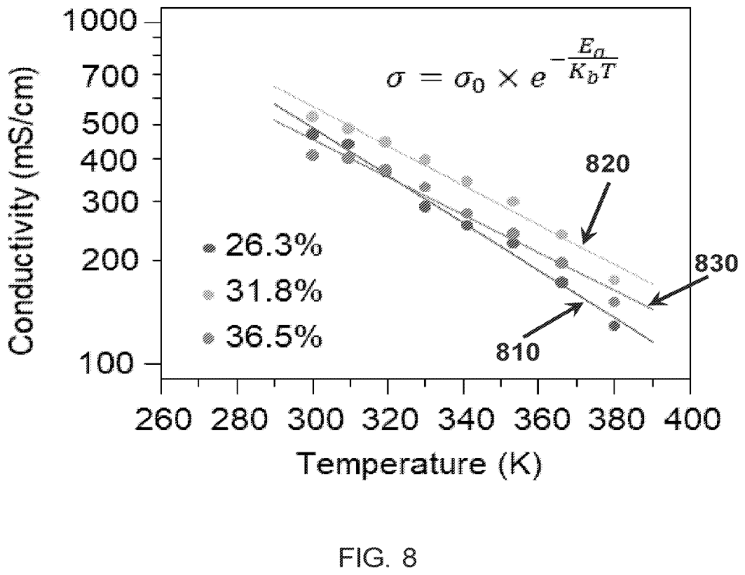

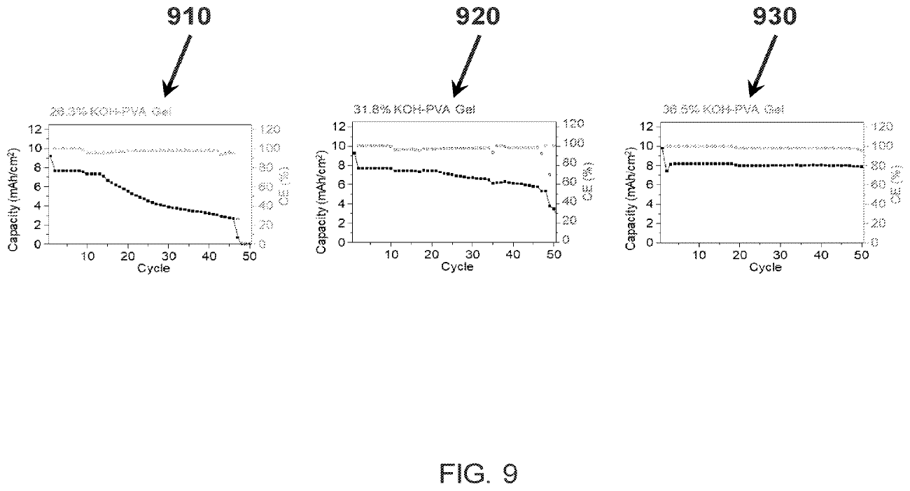

Overall, the porous electrodes grant easy permeation of the electrolyte, thus allowing the fabrication of cells with thicker electrodes to increase areal capacity. The conductivity of the PVA-based electrolyte (FIG. 2C) is in the 10² mS/cm order in a wide range of temperatures (e.g., −10° C. to 60° C.). The solid-phase hydrogel holds the ability to properly wet the electrodes which allows higher current cycling, while serving as a leak-free electrolyte barrier blocking dendrite growth. The hydroxide concentration was shown to have little effect on the electrolyte conductivity (FIG. 8) but had a significant impact to the cycle life of the battery (FIG. 9) and was thus optimized to be 36.5% by weight.

FIG. 8 shows example plots of the conductivity of the hydrogel with different caustic material concentrations. The linear trendlines were fitted using the equation given in the plot and listed in Table 1. Data series and related linear trendline 810 in FIG. 8 correspond to the caustic concentration of 26.3%. Data series and related linear trendline 820 in FIG. 8 correspond to the caustic concentration of 31.8%. Data series and related linear trendline 830 in FIG. 8 correspond to the caustic concentration of 36.5%.

TABLE 1
KOH-PVA electrolyte information.

| Caustic | Removed Precursor | σ₀ | Eₐ |
|---|---|---|---|
| Concentration | Water wt % | (mS/cm) | (eV) |
| 26.3% | 65.77% | 2.037 × 10⁴ | 0.109 |
| 31.8% | 70.72% | 3.155 × 10⁴ | 0.115 |
| 36.5% | 73.88% | 6.029 × 10⁴ | 0.138 |

FIG. 9 shows example cycling of the battery with electrolyte concentration of 26.3% (plot 910), 31.8% (plot 920), and 36.5% (plot 930). The 50% capacity range was used and the cells were cycled at the rate of 0.2 C.

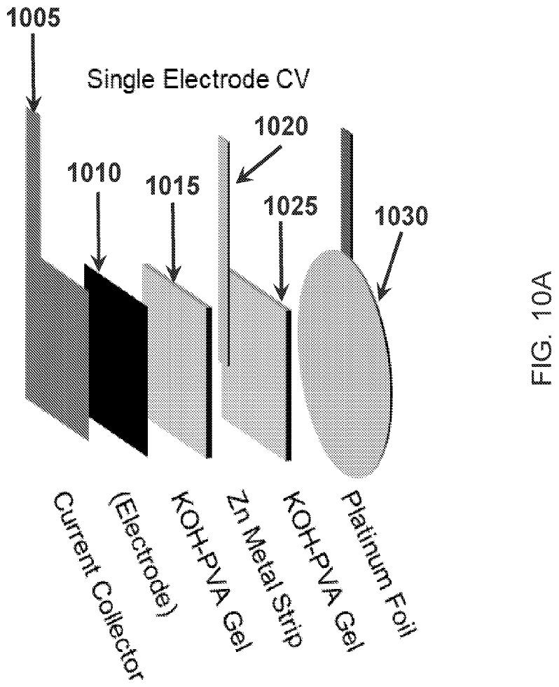

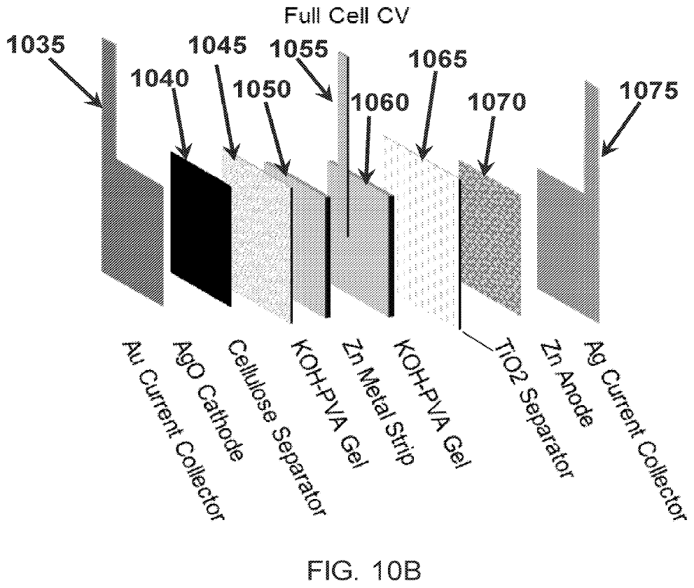

FIGS. 10A and 10B display 3-electrode cells that were used for cyclic voltammetry (CV) analysis using a Zn foil as a pseudo-reference electrode. The AgO—Zn battery according to some example embodiments is designed to charge and discharge within the window of 1.35 V to 2 V which is used as the CV scanning range. As shown in the full cell CV in FIG. 2D (plot 250 in FIG. 2D), within the scanning rate of 10 mV/s, the cell can undergo a high current density of up to 20 mA/cm², proving the cell's ability to discharge at high current. Using the external Zn reference, the full cell CV can be used to gauge the potential shifts of each electrode separately. As shown in FIG. 2D, the relative anode potential (plot 255 in FIG. 2D) does not shift significantly during the sweep, whereas the cathode potential (plot 260 in FIG. 2D) contributes to the majority of the potential change in the cell, suggesting that the AgO cathode is being the rate-limiting electrode in the charge-discharge process.

FIGS. 10A and 10B illustrate the structure of the cells used for the CV analysis. FIG. 10A shows the cell structure used for single electrode scanning for testing current collectors. The 3-electrode half-cell CV characterization was performed on a cell assembled with the printed electrodes (e.g., 1010 in FIG. 10A) as the working electrode, a platinum foil 1030 as the counter electrode, Zn metal foil (or strip) 1020 as the reference electrode, and 2 pieces of KOH-PVA hydrogel 1015 and 1025 as the electrolyte. The electrode 1010 (e.g., an anode or a cathode of a cell according to an example embodiment) in FIG. 10A is positioned between a current collector 1005 and the hydrogel 1015. FIG. 10B shows the cell structure used for full cell scanning with an external Zn metal strip as the reference electrode. The 3-electrode full-cell CV characterization was performed between 1.35 V to 2 V. In FIG. 10B, 1035 is a gold (Au) current collector; 1040 is an AgO cathode; 1045 is a cellulose separator; 1050 is a KOH-PVA hydrogel; 1055 is a Zn metal strip; 1060 is a KOH-PVA hydrogel; 1065 a TiO₂ separator; 1070 is a Zn anode; and 1075 is a silver (Ag) current collector.

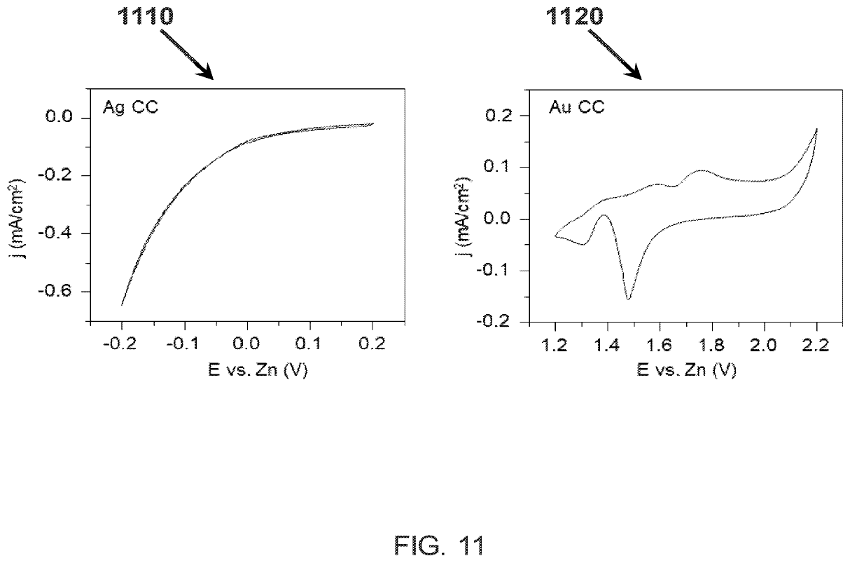

The CV of the current collectors in the corresponding voltage window (FIG. 11) is overlaid in FIG. 2D, plots 255 and 260, demonstrating the electrochemical stability of the current collectors within the expected potential range.

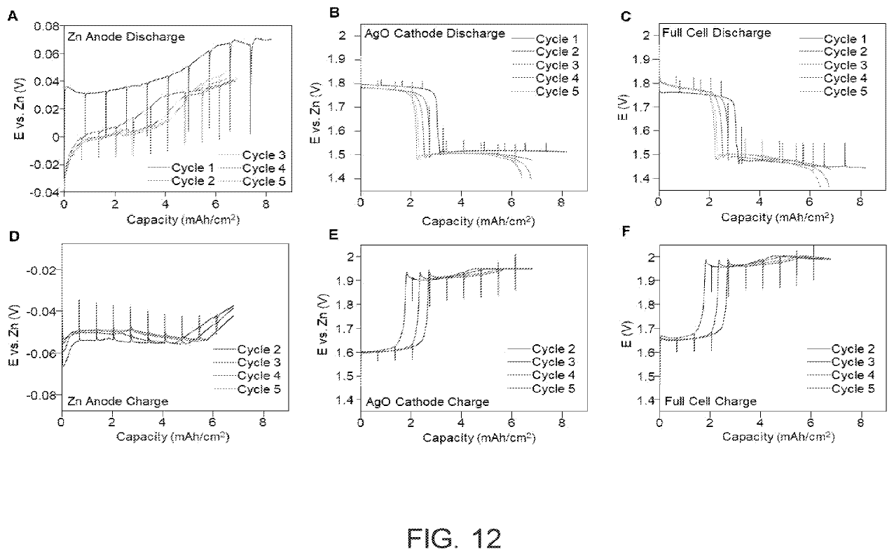

FIG. 11 shows an example CV of the printed Ag anode current collector (CC) in plot 1110 and the Au-sputtered carbon cathode CC in plot 1120 in their corresponding voltage ranges used in FIG. 2D, plots 255 and 260, respectively. Scan rate: 10 mV/s. It is worth noting that the current density of the Ag current collector increases towards the negative potential direction, which corresponds to the possible hydrogen evolution reaction taking place on the anode during the charging process. Such undesirable reaction is generally avoided as lower current density is used in the normal charging processes, corresponding to lower anode polarization (FIG. 12).

FIG. 12 shows the potential profile of the anode (plots A, D) and cathode (plots B, E) vs. Zn reference and the full cell (plots C, F) within the first 5 cycles of discharging (plots A-D) and corresponding 4 cycles of charging (plots D-F). The vertical lines in FIG. 12 correspond to the instances where EIS measurements were taken.

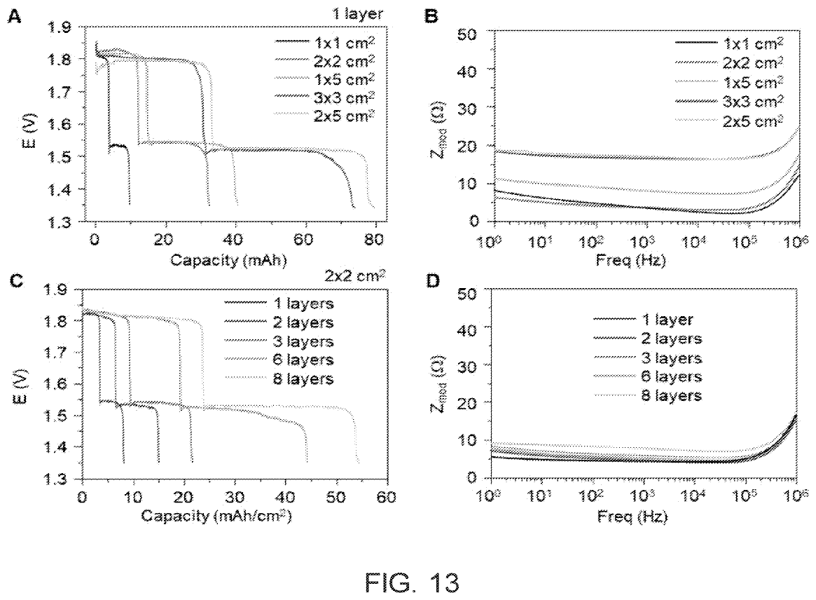

FIG. 13 shows data plots depicting example results of electrochemical performance characterization of AgO—Zn cells according to an example embodiment of the disclosed technology operated as primary batteries. Plot (A) in FIG. 13 shows the obtainable capacity of various sizes of cells that were printed with 1 layer of active materials and discharged at a current of 1 mA. Plot (B) in FIG. 13 shows Bode plots reflecting the corresponding impedance of cells of different sizes. Plot (C) in FIG. 13 shows the obtainable capacity of the 2×2 cm² cells with active material loading from 1 layer to 8 layers. Plot (D) in FIG. 13 shows Bode plots reflecting the corresponding impedance of the 2×2 cm² cells with different areal loading.

The ability of the cell design according to the disclosed technology to adapt to different cell sizes and areal loadings was evaluated. Cells with the same electrode thickness but different form factors, by varying the electrode designs, as well as the cells with the same form factors and different thicknesses by varying the number of layers of active material printed, were fabricated and discharged at a constant 1 mA current. As shown in FIG. 13 plot (A), cells with 1-layer (anode ˜120 μm, ˜45 mg/cm², cathode ˜75 μm, ˜26 mg/cm²) of electrode thickness with the sizes of 1×1 cm², 2×2 cm², 1×5 cm², 2×5 cm² and 3×3 cm² were prepared, and the capacity increases proportionally to the cell area, with an average areal capacity of 8 mAh/cm². The impedance of these cells was measured via 2 electrodes EIS, presented in FIG. 13 plot (B). The overall increase in impedance throughout the high frequency and low frequency domain suggests an increase in cell contact resistance, caused by the increase in resistance of the current collector as the cell size increases. Cells with a size of 2×2 cm² were also characterized with increasing areal loadings by printing 1, 2, 3, 6, and 8 layers of electrodes. As demonstrated in FIG. 13 plot (C), as the areal loading of active material increases, the areal capacity of the cell increases proportionally, reaching as high as 54 mAh/cm² with 8 layers of electrodes (anode ˜800 μm, ˜310 mg/cm², cathode ˜500 μm, ˜180 mg/cm²). The EIS on the cells with different thicknesses also showed no significant impedance increase as the thickness increases: only a minor increase in impedance in the low-frequency domain suggests a slight increase in the diffusion resistance due to thicker electrodes (FIG. 3 plot (D)). Such behavior can be attributed to the large pore sizes in both the anode and the cathode, which cause little resistance for the ion diffusion. Overall, the printed AgO—Zn cell according to an example embodiment of the disclosed technology was able to uphold superior performance in a wide range of sizes and areal loadings, thus proving its customizability as a primary thin-film battery to power various electronics with appropriate sizes and capacity.

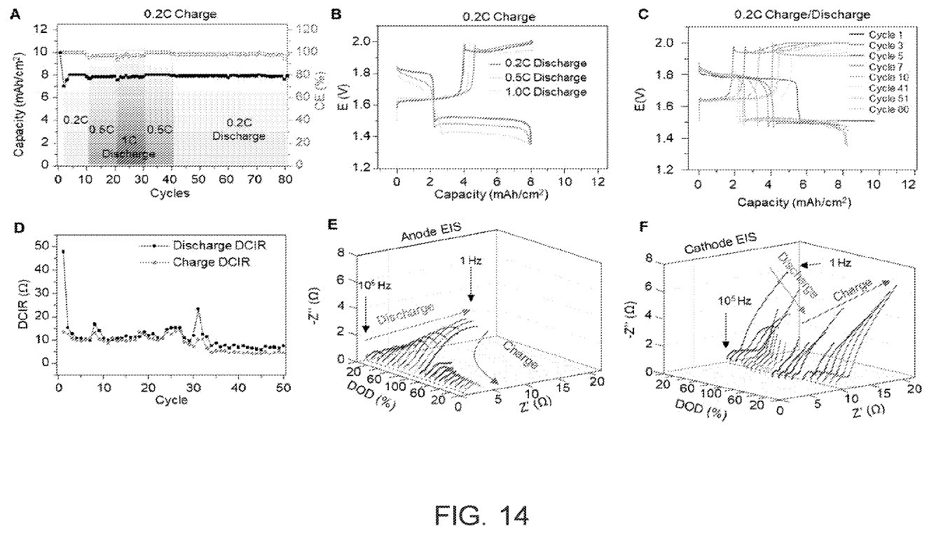

FIG. 14 shows data plots depicting example results of electrochemical performance characterization of AgO—Zn cells according to an example embodiment of the disclosed technology, when the cells were operated as rechargeable batteries. Plot (A) in FIG. 14 shows cycling performance of a printed AgO—Zn battery according to an example embodiment of the disclosed technology with a charging C-rate of 0.2C and varying discharge rate of 0.2C, 0.5C, and 1C. Plot (B) in FIG. 14 shows a voltage-capacity plot of the battery under different discharging C-rates. Plot (C) in FIG. 14 shows a voltage-capacity plot of the AgO—Zn battery at different number of cycles showing the stabilization of the charge-discharge profile. Plot (D) in FIG. 14 shows the direct current internal resistance (DCIR) of the AgO—Zn battery within 50 cycles cycled at the C-rate of 0.2C. Plot (E) in FIG. 14 shows the EIS profile of the Zn anode and plot (F) in FIG. 14 shows the EIS profile of the AgO cathode of the battery within 1 complete discharge-charge cycle on a 3-electrode cell with a Zn metal pseudo-reference electrode.

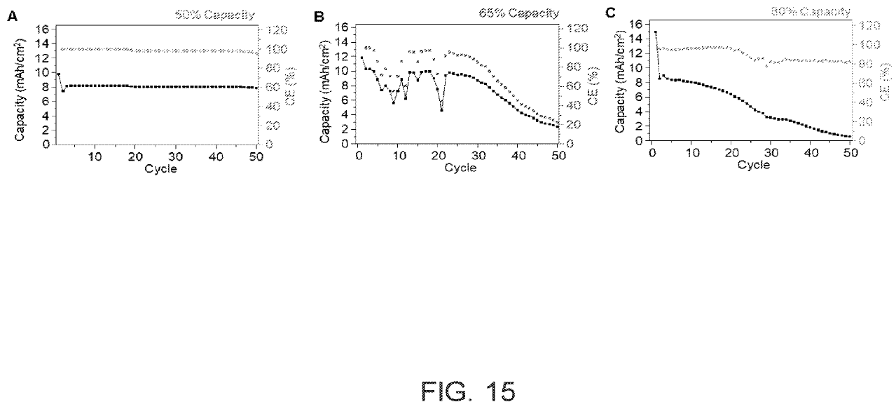

Beyond the application as a primary battery, the electrochemical performance of a flexible AgO—Zn battery according to an example embodiment of the disclosed technology as a secondary cell was also characterized. As a cell operating with conversion-type chemistry, it is crucial to avoid over-oxidation of the anode materials or over-reduction of the cathode material that would lead to irreversible particle shape change. A loss of capacity in this system is possible due to the increased thickness of the ZnO layer that passivates the anode surface, as well as the coarsening of the AgO/Ag₂O particles leading to a decrease in cathode surface area. Such behavior can be effectively mitigated by accurately controlling the degree of charge and discharge to limit the occurrence of irreversible electrode shape changes. The optimized charge-discharge algorithm according to the disclosed technology was determined to cycle the cell between 40% and 90% of its maximum capacity, with larger ranges resulting in lower cycle life as shown in FIG. 15.

FIG. 15 shows the cycling of the battery at different capacity ranges. FIG. 15, plot (A), shows cycling the battery between 40% and 90% state of charge (50%). FIG. 15, plot (B), shows cycling the battery between 25% and 90% state of charge (65%). FIG. 15, plot (C), shows cycling the battery between 10% and 90% state of charge (80%). Electrolyte with the concentration of 36.5% was used, and the cells were cycled at the rate of 0.2 C.

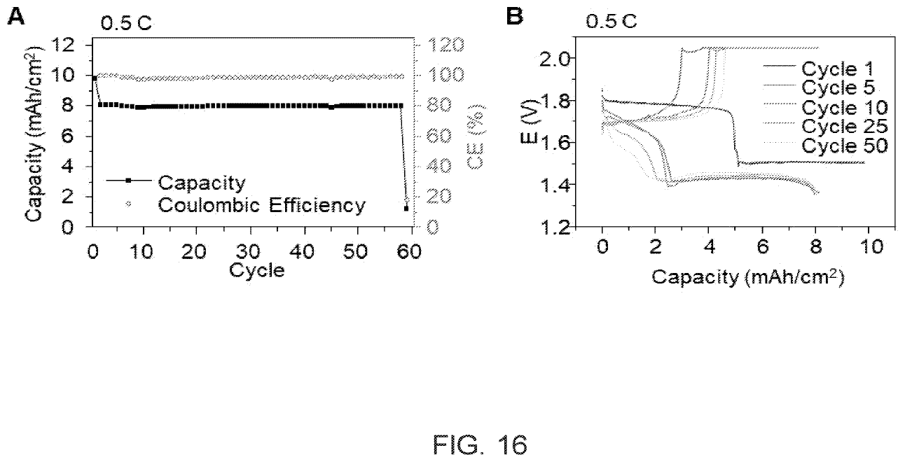

Referring back to FIG. 14, plot (A), demonstrates the cycling of a battery according to an example embodiment of the disclosed technology with 2-layer electrodes with a maximum capacity of ˜16 mAh/cm². A formation cycle is firstly performed, discharging 10 mAh/cm² (60% of max. areal capacity) at the rate of 0.1C, allowing the electrode to slowly relax into its preferred morphology with increased surface area and reduced impedance. Then, the battery was charged at 0.2 C rate until reaching 2 V and charged at constant voltage until the C-rate dropped to below 0.04 C or the capacity reached 8 mAh/cm² (50% of max. areal capacity). The battery was then discharged at 0.2 C until reaching a columbic efficiency of 100% or a voltage of 1.35V. The entire charge-discharge process is accurately controlled by capacity in the initial cycles, ensuring the cell is cycled between 40% to 90% of its maximum capacity. As shown in FIG. 14, plot (C), after a few cycles at the rate of 0.2 C, the cell slowly relaxed from capacity-controlled discharge to voltage-controlled discharge, with the higher plateau to lower plateau ratio resembling the behavior of the primary cells. Using such charge-discharge algorithm, the cycle life of the unstable AgO oxidation state could be controlled, and a significantly increased cycle life can be obtained. Due to the supersaturation-precipitation reaction mechanism of both the anode and the cathode during discharge, the cell can be discharged at a high C-rate of up to 1 C without any loss in capacity and columbic efficiency, as shown in FIG. 14, plots (A) and (B). Recharging at a higher C-rate is also possible, as shown in FIG. 16, although this would require a higher capping voltage, reducing the rechargeability and increasing and the risk of oxygen evolution on the cathode, thus was not preferred.

FIG. 16 shows the cycling of the battery according to an example embodiment of the disclosed technology at the rate of 0.5 C. The electrolyte with the concentration of 36.5% and the capacity range of 50% was used.

Impedance measurements of the flexible batteries according to the disclosed technology showed relatively low impedances throughout cycling. The impedances of the batteries were either determined during cycling of the full-cell using direct current internal resistance (DCIR) method, or during cycling of the separated anode and cathode half-cells using a 3-electrode configuration with a Zn foil serving as the reference. The DCIR analysis offers a straightforward and simple way to gauge the change in the internal resistance of the battery. As shown in FIG. 14, plot (D), 2-electrode DCIR analysis with both charging and discharging current was performed before each charge and discharge for a battery cycling at 0.2 C, and the battery was able to maintain low internal resistance throughout the cycles, suggesting no formation of high-impedance passivating layers on the surface of the battery electrodes throughout cycling. To obtain detailed information on the change in the impedance of each electrode during each cycle, multiple 3-electrode EIS analyses were performed on the battery while cycling at 0.2 C and are plotted against the degree of discharge (DOD) of the battery. As presented in FIG. 14, plot (E), the anode half-cell started at a low impedance of 1-4Ω, with 2 depressed semicircles attributed to the high-speed charge transfer at the Zn particle interface and the lower speed hydroxide ions (OH—) diffusion in the porous network. With discharging the low-frequency semicircle slowly expands due to the formation and growth of the ZnO species that impedes the OH⁻transport and increases the double-layer capacitance. During charging, the oxygen species are liberated from the reactions in Equations 1-3 to form OH⁻ions that diffuse readily out of the anode. This results in the fast mass transport of OH⁻ions out of the anode and a rapid drop in the impedance at the onset of charging that eventually recovers to the initial level, thus showing the reversibility of stripping and depositing of Zn on the anode. For the cathode half-cell EIS shown in FIG. 14, plot (F), at the start of the discharge (0% DOD), a single semi-circle corresponding to the mass transfer resistance and capacitance of the Ag₂O formation is observed with a low-frequency impedance tail at an angle of approximately 45° suggesting standard Warburg diffusion of OH⁻. As the cell is discharged, the overall impedance decreases with a second semicircle emerging near the low-frequency domain that can be attributed to the charge transfer resistance and capacitance of Ag formation from Ag₂O. During charging, this second low-frequency semicircle disappears as all the Ag oxidizes to form Ag₂O and eventually AgO.

Overall, the 3-electrode impedance results provide a deep insight into the reaction and possible routes in improving the battery's cycle-life and performance. These data indicate that the impedance of the AgO cathode is responsible for the majority of the cell impedance. Incorporation of additives can increase the cathode electrical conductivity to improve the performance in high-current applications. For the anode, the monitoring of ZnO formation via EIS can be paired with topological characterization methods to control the conversion of Zn electrodes towards extended cycle life.

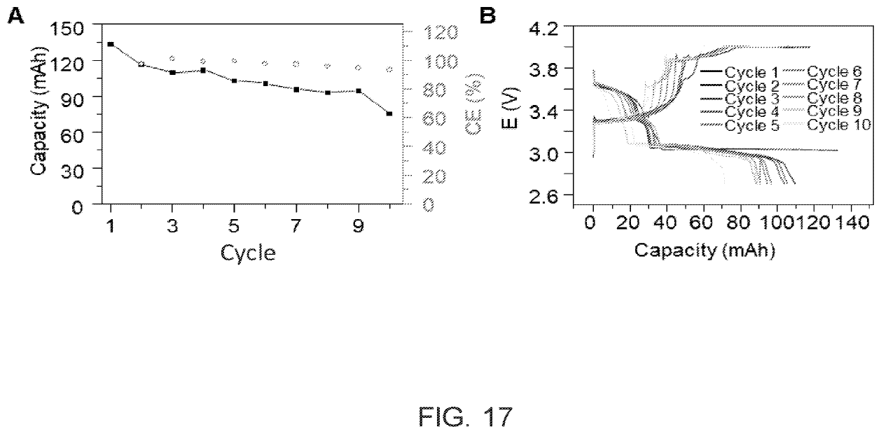

FIG. 17 shows the cycling at the rate of 0.05 C of two 8-layer2×2 cm² batteries according to an example embodiment of the disclosed technology connected in series.

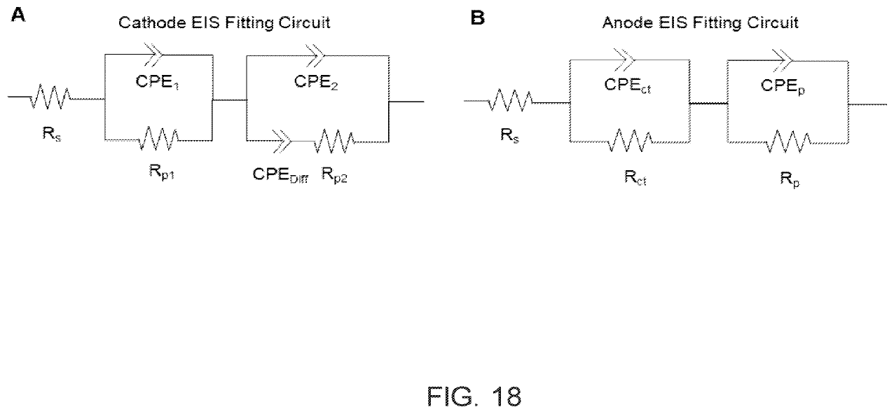

FIG. 18 shows the equivalent circuits used for the cathode (panel A) and anode (panel B) EIS fitting.

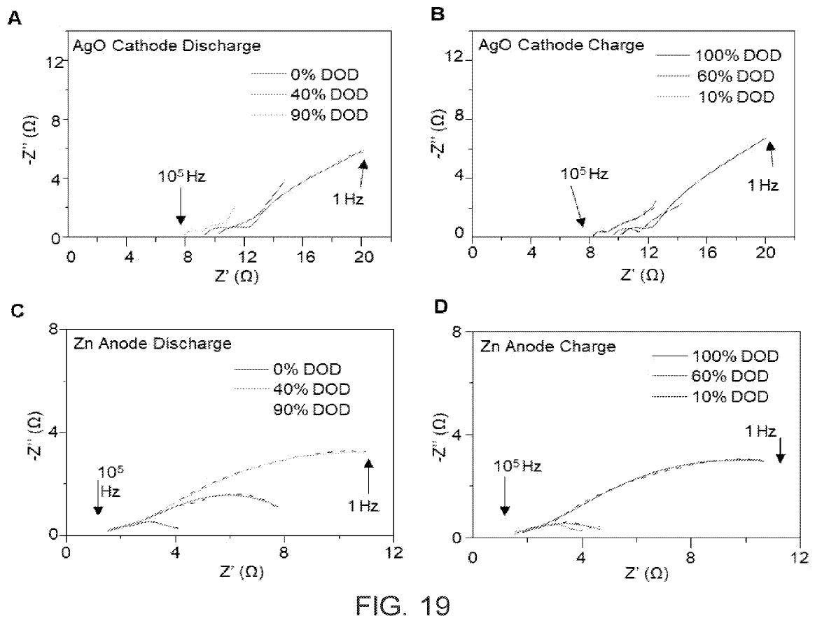

FIG. 19 shows the Nyquist plot and the EIS fitting of the cathode during the 5th cycle discharging (panel A) and charging (panel B), and the corresponding anode charging (panel C) and discharging (panel D).

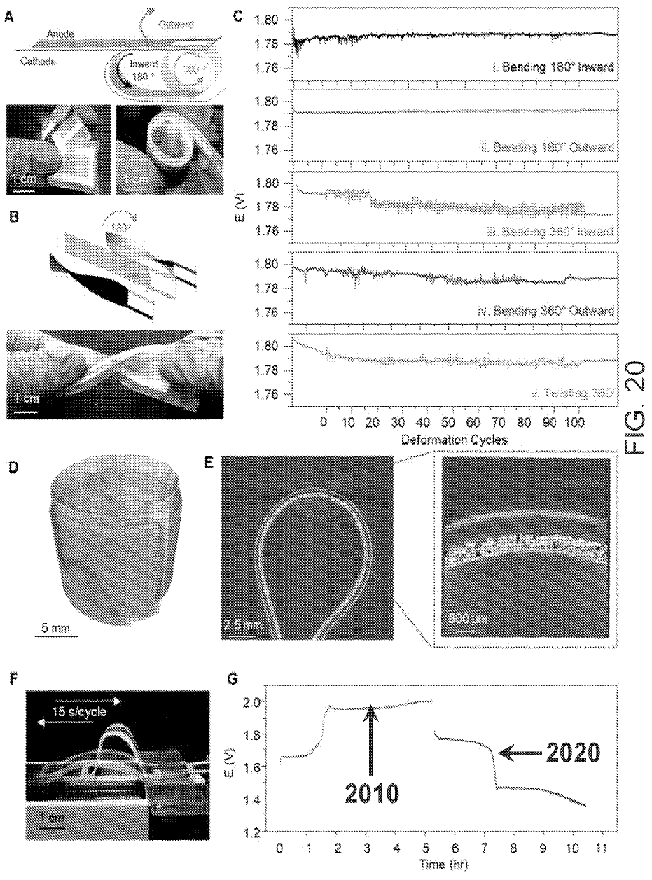

FIG. 20 shows images, diagrams and plots depicting example results of the performance characterization of an AgO—Zn cell according to an example embodiment of the disclosed technology under various mechanical deformations. Plots (A) and (B) in FIG. 20 show illustrations and corresponding images of a 2-layer loading, 1×5 cm² battery according to an example embodiment undergoing 180° and 360° bending deformations (plot (A)) and 360° twisting deformation (plot (B)). Plot (C) in FIG. 20 shows the corresponding voltage profile of the battery during 1 mA discharge while undergoing 100 cycles of 180° outward bending (panel i), 180° inward bending (panel ii), 360° inward bending (panel iii), 360° outward bending with a bending diameter of 1 cm (panel iv), and 360° head-to-end twisting (panel v). Plot (D) in FIG. 20 shows a micro-CT image of the entire 1×5 cm² cell after repeated bending and twisting cycles rolled in a diameter of 1 cm, and plot (E) in FIG. 20 shows a cross-section of it bent in a diameter of 1 cm (left) and a zoomed-in view (right) of the electrodes, demonstrating no structural damage or delamination of the cell after repeated mechanical deformations. Plot (F) FIG. 20 shows an illustration of a battery under repeated 180° bending cycles controlled by a linear stage at the speed of 15 s/cycle, and plot (G) in FIG. 20 shows the corresponding voltage-time plot of the charging (curve 2010) and discharging (curve 2020) of the battery during˜2500 repetitions of bending.

Compared to coin-cell, cylindrical or prismatic cells, the printed flexible batteries according to the disclosed technology have the unique advantage of allowing bending, flexing, and twisting without causing their structural failure. To endow such mechanical resiliency, the printed AgO—Zn batteries according to the disclosed technology are composed of flexible and stretchable polymer-particle composite layers which use highly elastic binders. These flexibility and stretchability allow the layers of the battery to deform to release the inter-layer strain, thus allowing the battery to endure large deformation without delamination between its layers or build-up of fatigue, even when very thick electrodes are used. To test the performance of the batteries under severe strain, a 2-layer 1×5 cm² cell (also referred to as battery) was fabricated according to an example embodiment of the disclosed technology and discharged at a current of 1 mA while undergoing repeated bending and twisting deformations. As illustrated in FIG. 20, plots (A) and (B), the cell was tested with 180° and 360° bending in both directions with a bending radius of 0.5 cm, as well as 180° twisted in both directions from head to end. The corresponding voltage change during 100 cycles (1 s per cycle) of deformation was recorded, as shown in FIG. 20, plot (C). In general, the cell exhibited stable performance during bending and twisting in both directions, with negligible fluctuation in voltage during the 180° bending cycles, and roughly 10 mV fluctuation during the 180° bending and twisting cycles. The inward bending in general shows slightly more variations, which is suspected to be caused by the softer Ag current collector on the anode side undergoing more stretching on the outside during bending. To ensure the mechanical stability of the cell, micro-CT was used to characterize the cell after the repeated deformation. As shown in FIG. 20, plots (D) and (E), the entire cell can be scanned at a high resolution to obtain a 3-dimensional (3D) image reflecting the microscopic structure of the cell under deformation. The zoom-in view of a cross-section of the battery further shows no cracks or delamination after the repeated deformation cycles, reflecting the robust mechanical resiliency of the battery. The rechargeability of the cell is also not interrupted by the repeated deformation, as shown in FIG. 20, plots (F) and (G), where the battery can be normally charged and discharged while undergoing ˜2500 cycles of 180° bending. Overall, pairing the superior electrochemical and mechanical performance, the printed thin-film AgO—Zn battery according to the technology disclosed herein is proven to be well-suited to reliably and sustainably power various wearable and flexible electronics.

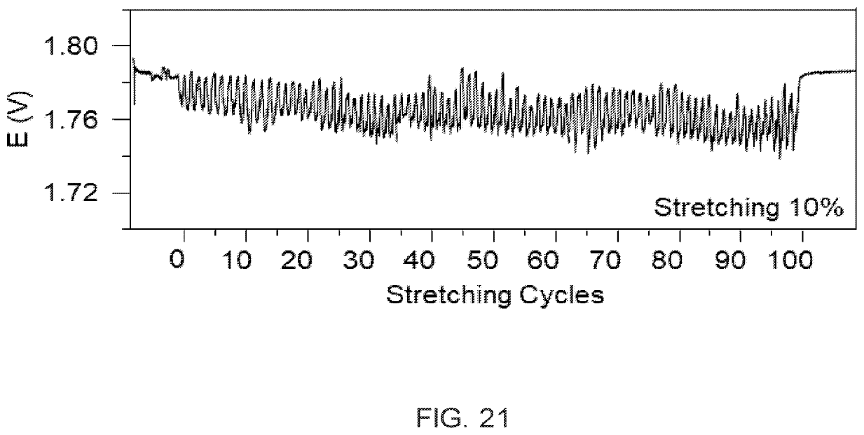

FIG. 21 shows a voltage profile of a 1×5 cm² battery according to an example embodiment of the disclosed technology collected during 1 mA discharge while the battery was undergoing 100 cycles of 10% lengthwise stretching. A certain amount of stretchability is also required for the battery to endure low-radius bending and accommodate for the outer-layer strain. 3D illustrations of the battery under bending deformation can be found in FIG. 3.

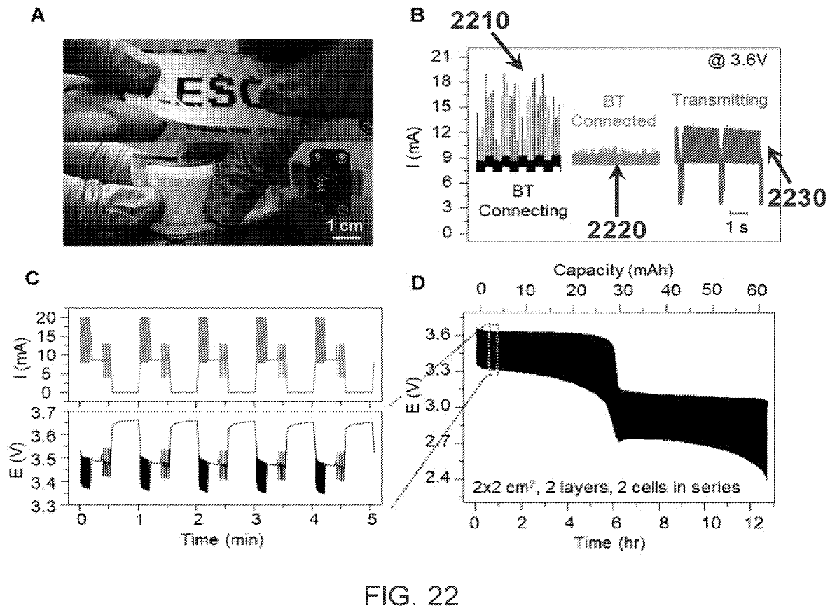

FIG. 22 shows example images and plots depicting powering of a flexible E-ink display system by flexible AgO—Zn batteries according to an example embodiment of the technology disclosed in this patent document. Panel (A) in FIG. 22 shows images of the flexible E-ink display and placement of two 2-layer loading, 2×2 cm² batteries according to the technology disclosed herein which are connected in series on the back of the display. Plot (B) in FIG. 22 shows the power consumption of the E-ink display system with integrated Bluetooth (BT) and microcontroller unit (MCU) modules during BT connection (trace 2210), after establishing the connection (trace 2220), and during active data transmission (trace 2230). FIG. 22, plot (C), shows a simulated discharge current profile with varying pulses and baselines (top) and the corresponding voltage response of the battery (bottom). FIG. 22, plot (D), shows a complete discharge profile of the two cells connected in series implementing the simulation discharge profile.

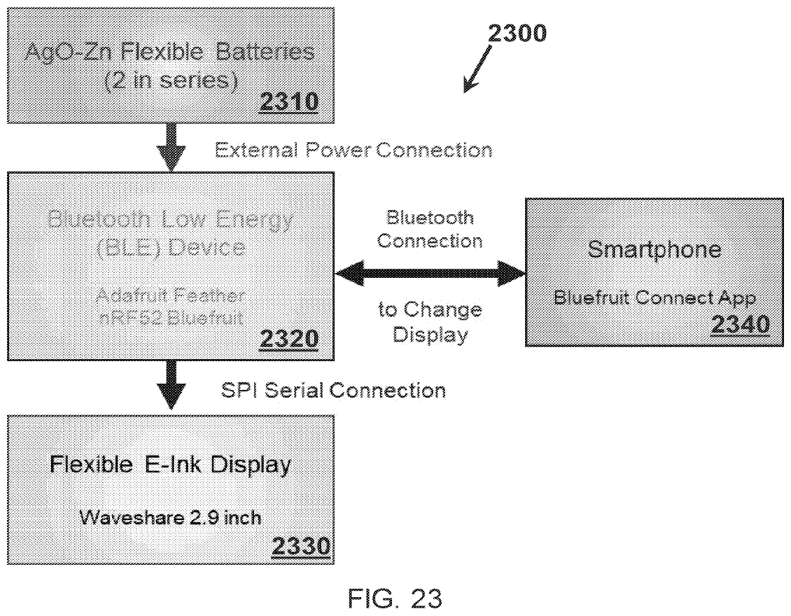

To demonstrate performance of the batteries according to the disclosed technology powering typical flexible electronics, we designed a flexible E-ink display system controlled by an Arduino-type microcontroller unit with added Bluetooth (BT) communication module (FIG. 22 plot (A) and FIG. 23). The system is powered by two 2×2 cm² batteries with 2-layer electrodes according to an example embodiment of the disclosed technology connected in series, which can supply enough voltage (>3 V) to boot the system. A mobile device, e.g., a smartphone, can connect and transmit data and commands to the BT module, which is processed by the microcontroller that refreshes the E-ink display. First, the energy consumption of the system under different operation modes operating at 3.6 V was measured. Plot (B) in FIG. 22 displays the current draw when (1) the system is broadcasting to seek for connection, which contains short bursts of current peaks around 20 mA (trace 2210 in FIG. 22, plot (B)); (2) the system is connected to a mobile device (a cellphone), with an average current of 9 mA (trace 2220); and (3) the system is actively transmitting data between the cellphone and the display, with the current alternating between a higher baseline of 8.5 mA with peaks of 13 mA, and a lower baseline of 4 mA with peaks of 10 mA (trace 2230). The batteries are thus discharged using a script simulating the power consumption of the flexible E-ink display system working in repeated discrete sessions, with 10 s of BT broadcasting, 10 s of idle after establishing the connection, 10 s of active data transmission, followed by 30 s of resting (powered off) (FIG. 22, plot (C)). As illustrated in FIG. 22, plot (D), the two batteries in series were able to sustain the pulsed, high-current discharge in the 3.6 V-2.4 V window to deliver power to the system constantly for over 12 hours, and were able to maintain their capacity of ˜60 mAh, similar to the capacity obtained from the constant low-current 1 mA discharge. By pairing with the high-areal capacity flexible AgO—Zn battery according to the disclosed technology, the flexible E-ink display was able to operate while undergoing bending deformations. In comparison, commercial lithium coin cells with similar rated capacity were not able to sustain the high current pulsed discharge, resulting in a significant loss in capacity when discharged using the same script. The low-impedance and high-energy-density batteries according to the technology disclosed in this patent document are therefore proven to have both outstanding electrochemical and mechanical performance for powering of a typical prototype of a flexible electronic system. With their performance even surpassing its non-flexible commercial coin cell counterpart, such all-printed batteries can be considered extremely attractive due to their customizability, and flexibility towards real-life applications. A typical application of using the battery to illuminate an LED bulb while applying various mechanical deformations was also tested, where the light intensity did not change as the battery was bent, folded, twisted, and stretched.

FIG. 23 shows a diagram of the assembled flexible E-ink display system 2300. The system 2300 includes two AgO—Zn flexible batteries according to the disclosed technology connected in series (2310). The system 2300 further includes a Bluetooth low energy (BLE) device 2320 (e.g., Adafruit Feather mRF52 Bluefruit). The batteries 2310 are electrically connected to an external power connector of the device 2320. The system 2300 also includes a flexible e-ink display 2330 (e.g., Waveshare 2.9 inch one) coupled to the device 2320 via a SPI serial connection. The device 2320 is communicatively coupled, via a Bluetooth connection, to a smartphone 2340 running Bluefruit Connect app which allows changing contents displayed by the display 2330.

Flexible and high-performance thin-film AgO—Zn batteries according to the disclosed technology are based on rechargeable conversion chemistry. Using specially formulated ink with stretchable elastomeric binders and thermoplastic elastomeric substrates, the batteries according to the disclosed technology can be printed layer-by-layer using, e.g., low-cost, high-throughput screen-printing techniques and assembled with a heat and vacuum sealing processes, for example. To obtain a low device footprint while maintaining easy processability, printable and flexible separators and solid-phase KOH-PVA hydrogel were developed to allow a stacked sandwich configuration. Printable batteries according to the technology disclosed herein are compatible with various cell sizes and areal loading, leading to a high areal capacity of, e.g., 54 mAh/cm² in connection to repeated multilayer printing for primary applications. The batteries are also rechargeable (e.g., upon implementing the capacity-controlled cycling algorithm described above), with high cycle life beyond 70 cycles with varying discharge C-rates without loss in capacity and coulombic efficiency. The batteries exhibited low impedance within each discharge-charge cycle, while maintaining low internal resistance throughout multiple cycles, suggesting stable and reversible electrode morphological change during electrode redox reactions. As a flexible energy storage unit for powering various flexible, wearable electronics, the performance of a battery according to an example embodiment of the disclosed technology was evaluated under rigorous mechanical testing, demonstrating that the battery offers remarkable resiliency against repeated large deformation bending and twisting cycles. The fabricated batteries were used in the powering of a customized flexible E-ink display system with BT connectivity and delivered an outstanding performance that surpassed commercial coin cells under the high-current pulsed discharge regime required by the electronics. The example implementations demonstrate the scalable fabrication of flexible thin-film AgO—Zn batteries with highly desirable electrochemical and mechanical performance and tremendous implications towards the development of novel energy storage devices for the powering of next-generation electronics.

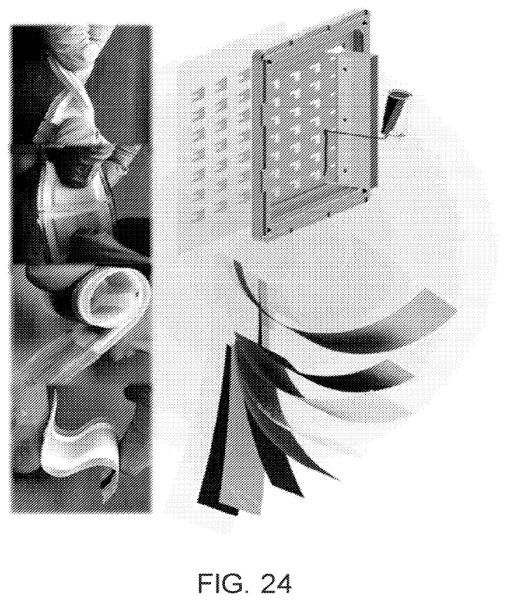

FIG. 24 shows an illustration of an example manufacturing technique and product using the disclosed chemical-resistant, flexible elastomer binder material. The illustration in FIG. 24 shows the example polymer-based printing fabrication of a battery with a high areal density (e.g., about 54 mAh/cm²). The battery is flexible, rechargeable, low impedance, customizable, and has a low device footprint. The example battery demonstrates superior battery performance in pulsed high current discharge mode.

Bi₂O₃, Ca(OH)₂, KOH (pellets, ≥85%), LiOH, methyl isobutyl ketone (MIBK), toluene, cellulose (microcrystalline powder, 20 μm), Triton-X 114, Poly(ethylene oxide) (PEO) (MW 600,000), and PVA (MW=89000-98000, 99+% Hydrolyzed) were purchased from Sigma Aldrich (St. Louis, MO, USA). Zn, AgO, and TiO₂ were obtained from Zpower LLC (Camarillo, CA, USA). The fluorocopolymer (GBR-6005, poly(vinylfluoride-co-2,3,3,3-tetrafluoropropylene)) was obtained from Daikin US Corporation (New York, NY, USA). SEBS (G1645) was obtained from Kraton (Houston, TX, USA). Graphite powder was purchased from Acros Organics (USA). Super-P carbon black was purchased from MTI Corporation (Richmond, CA, USA). All reagents were used without further purification.

The electrode resin was prepared by adding 5 g of the fluorine rubber in 10 g of MIBK solvent and left on a shake table until the mixture was homogeneous. The SEBS resin was prepared by adding 40 g of the SEBS into 100 mL of toluene and left on a shake table until the mixture was homogeneous.

The silver current collector ink was formulated by combining Ag flakes, SEBS resin, and toluene in 4:2:1 weight ratio and mixing in a planetary mixer (Flaktak Speedmixer™ DAC 150.1 FV) at 1800 rotations per minute (RPM) for 5 minutes. The carbon current collector ink was formulated by firstly mixing graphite, Super-P, and PTFE powder in 84:14:2 weight ratio with a set of pestle and mortar. The mixed powder was mixed with the SEBS resin and toluene in a 10:12:3 weight ratio using the mixer at 2250 RPM for 10 minutes to obtain a printable ink. The Zn anode ink was formulated by firstly mixing the Zn and Bi₂O₃ powders in a 9:1 ratio with a set of pestle and mortar until the Zn particles are evenly coated with the Bi₂O₃ powder. The evenly mixed powder was then mixed with the electrode resin and MIBK in a 20:4:1 weight ratio using the mixer at 1800 RPM for 5 minutes to obtain a printable ink. The AgO cathode ink was formulated by firstly mixing the AgO and Super-P powders in a 95:5 weight ratio using a set of pestle and mortar until homogeneous. The powder was then mixed with the electrode resin and MIBK in 5:5:2 weight ratio using the mixer at 2250 RPM for 5 minutes to obtain a printable ink.

The TiO₂ separator ink was prepared by firstly mixing TiO₂ and cellulose powder in a 2:1 ratio using a set of pestle and mortar. The mixed powder was then added with the SEBS resin, toluene and Triton-X in 50:55:75:3 weight ratio and mixed with the mixer at 2250 RPM for 10 minutes to obtain a printable ink. The cellulose separator ink was prepared by firstly mixing TiO₂ and cellulose powder in a 26:9 ratio using a set of pestle and mortar. The mixed powder was then added with the electrode resin, MIBK in an 8:7:4 weight ratio and mixed with the mixer at 2250 RPM for 10 minutes to obtain a printable ink.

A resin with 40.8 wt % of SEBS dissolved in toluene was prepared and left on a linear shaker (Scilogex, SK-L180-E) overnight or until the mixture became transparent and homogeneous. Wax paper was used as the temporary casting substrate, and a film caster with the clearance of 1000 um was used to cast the SEBS resin onto the wax paper. The cast resin was firstly dried in the ambient environment for 1 h, followed by curing in a conventional oven at 80° C. for 1 h to remove the excess solvent. The transparent, uniform SEBS film, which can be readily peeled off from the wax paper after curing, was used as the substrate for subsequent battery printing.

Stencils for printing the current collectors, electrodes, and separators were designed using AutoCAD software (Autodesk, San Rafael, CA, USA) and produced by Metal Etch Services (San Marcos, CA), with dimensions of 12 in×12 in. The thickness of the stencils was designed to be 100 μm for the carbon and silver current collectors, 300 μm for the TiO₂ separator and the Zn anode, and 500 μm for the cellulose separator and the AgO cathode. To print the anode, the silver ink was first printed onto the SEBS substrate and cured in a conventional oven at 80° C. for 10 minutes. The Zn ink was then printed onto the silver current collectors and cured at 80° C. for 30 minutes. The TiO₂ ink was lastly printed onto the anode and cured at 80° C. for 10 minutes. To print the cathode, the carbon ink was firstly printed onto the SEBS substrate and cured at 80° C. for 10 minutes. PET sheets were cut using a computer-controlled cutting machine (Cricut Maker®, Cricut, Inc., South Jordan, UT, USA) into a mask exposing the printed carbon electrodes, and the masked carbon current collector was sputtered with ˜400 nm of Au and adhesion interlayer of Cr at a DC power of 100 W and 200 W, respectively, and an Ar gas flow rate of 16 SCCM using a Denton Discovery 635 Sputter System (Denton Discovery 635 Sputter System, Denton Vacuum, LLC, Moorestown, NJ, USA). The AgO ink was then printed onto the sputtered current collectors and cured at 50° C. for 60 minutes. Lastly, the cellulose ink was printed onto the cathode and cured at 50° C. for 60 minutes. To print multiple layers of electrodes or the separators, the stencil was offset by an additional 65 μm for each layer of AgO and 100 μm for each layer of Zn to compensate for the electrode thickness.

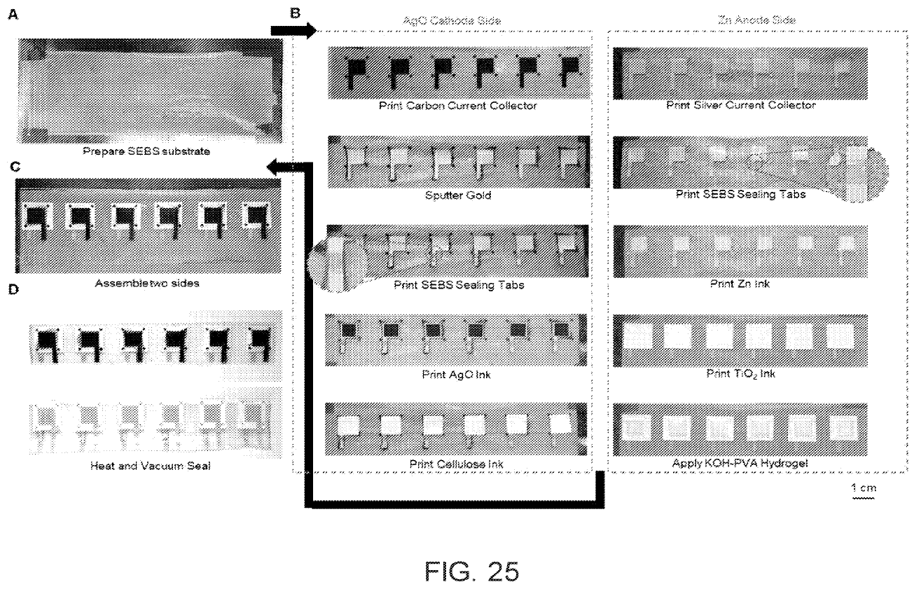

FIG. 25 shows example images of step-by-step batched fabrication of the printed AgO—Zn batteries according to the technology disclosed herein. Panel (A) in FIG. 25 shows a prepared SEBS substrate. Panel (B) in FIG. 25 shows a layer-by-layer printing process, according to an example embodiment of a method according to the disclosed technology, of the AgO cathode (left) and the Zn anode (right) of an AgO—Zn battery according to an example embodiment of the technology disclosed herein. Panel (C) in FIG. 25 illustrates placing the cathode side onto the anode side with the hydrogel electrolyte in between. Panel (D) in FIG. 25 illustrates the process of heat and vacuum sealing of the batteries. Each cell was separated by further heat sealing after the entire batch was vacuum sealed.

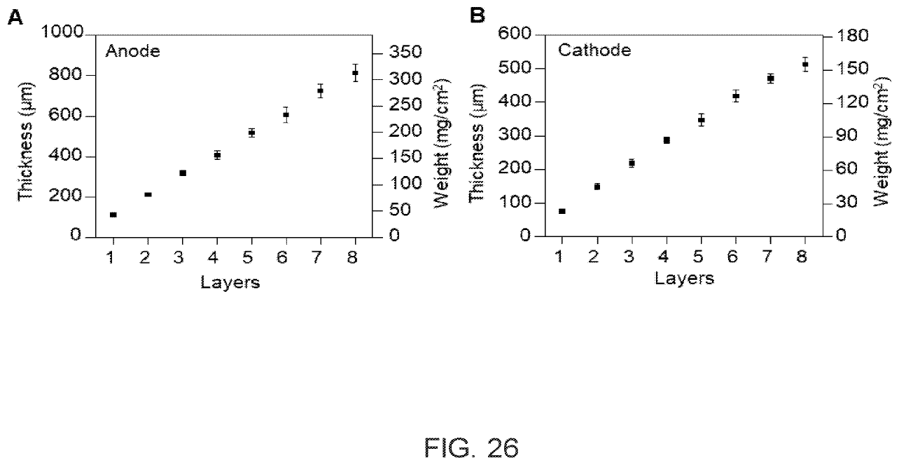

FIG. 26 shows example results of thickness calibration of the (A) anode and (B) cathode printed using their corresponding stencils. 5 samples were taken to generate the average and standard deviation values for each data point.

The hydrogel used in some example embodiments of the batteries according to the disclosed technology is synthesized by mixing the PVA solution and the hydroxide solution into a gel precursor and dried in a desiccator until the desired weight is reached. For synthesizing the 36.5% hydroxide gel used in some example embodiments, the following formulations were used. A hydroxide solution was prepared by dissolving 9.426 g KOH and 0.342 g LiOH into 50 mL deionized (DI) water. 0.5g Ca(OH)₂ was then added into the solution and stirred in a closed container under room temperature for 1 hour to saturate the solution with Ca(OH)₂, and the excess Ca(OH)₂ was then removed from the solution. A PVA solution was prepared by dissolving 4.033 g PVA and 0.056 g PEO into 50 mL DI water heated to 90° C. The precursor solution was prepared by mixing the hydroxide solution and the PVA solution in the weight ratio of 13.677:10 and poured into a flat petri dish with the weight of 0.2 g/cm₂. The precursor was left to dry in a vacuum desiccator until the weight decreased to 26.12% of precursor weight to obtain a soft, translucent hydrogel with its caustic material taking 36.5% of the sum of caustic material and the water content. Additional weight and conductivity information for different hydroxide concentrations can be found in Table 1. The hydrogel can be then cut into desired sizes and directly used or stored in a hydroxide solution with the same weight ratio of hydroxide without PVA. The storage solution for the 36.5% KOH-PVA gel was prepared similar to the hydroxide solution, where 10.777 g KOH, 0.391 g LiOH, and 0.5 g Ca(OH)₂ were dissolved into 15 mL DI water and the excess Ca(OH)₂ was removed.

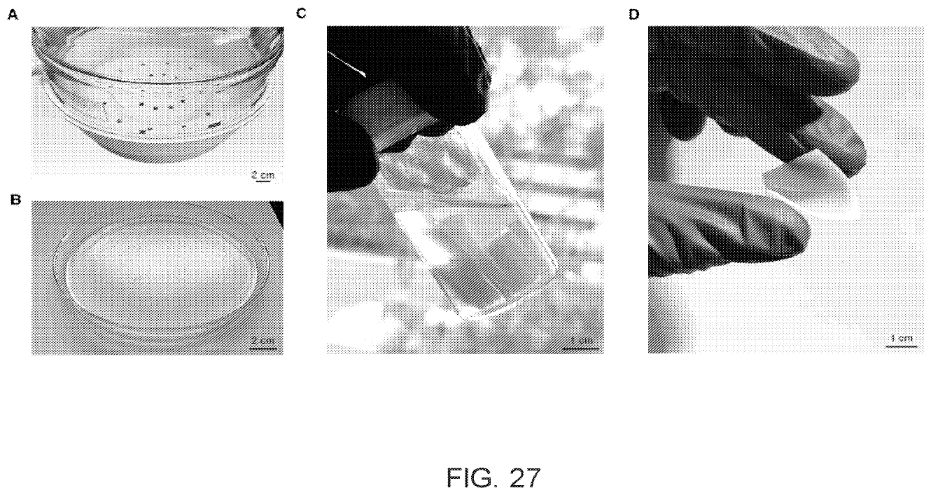

FIG. 27 shows example images taken during fabrication of the KOH-PVA electrolyte gel according to an example embodiment of a fabrication method according to the disclosed technology. Image (A) in FIG. 27 illustrates drying of the precursor solution to desired concentration in a vacuum desiccator. Image (B) in FIG. 27 illustrates the crosslinked 36.5% hydrogel after drying. Image (C) in FIG. 27 illustrates storage of the hydrogel pieces after cutting into desired sizes. Image (D) in FIG. 27 illustrates a bent 2×2 cm² hydrogel piece.

Morphological analyses of the current collectors, separators, and active material electrodes were performed with SEM and micro-CT. SEM images were taken using a FEI Quanta FEG 250 instrument with an electron beam energy of 15 keV, a spot size of 3, and a dwell time of 10 μs. Micro-CT experiments were conducted using a ZEISS Xradia 510 Versa. For individual film analysis, micro-CT samples were prepared by punching 2 mm radii disks and stacking them in a PTFE cylindrical tube with alternating PTFE films to provide separation between neighboring film disks. For the Micro-CT of full and sealed cell bending, a 1×5 cm² Zn—AgO battery was bent or rolled around a polyethylene (PE) cylindrical tube with a diameter of 1 cm.

For the micro-CT of active material electrodes, the heavier metals, such as Zn and Ag, warranted higher X-Ray energies than the printed polymer separator films. Accordingly, scans at 140 keV and a current of 71.26 μA were performed with high energy filters and a magnification of 4× on the Zn and AgO films with voxel sizes of 2.5 μm and 0.75 μm and exposure times of 2 s and 18 s, respectively. For the polymer separators, 80 keV scans with an 87.63 μA current were used with low energy filters at a magnification of 4× with voxel resolutions of 0.75 μm and 1.1 μm and exposure times of 8 s and 1 s for the printed anode and cathode separators, respectively. For scans of the full cell bending, a voltage of 140 keV and a current of 71.26 μA with a 4× magnification were performed with the following voxel resolutions and exposure times for the respective cases: 18.35 μm and 2 s for low resolution bending scan, 3.54 μm and 5 s for higher resolution bending scan, and 7.55μm and 2 s for rolled cell scan. For all micro-CT scans conducted, 1801 projections were taken for a full 360° rotation with beam hardening and center shift constants implemented during the data reconstruction. Post measurement imaging and analysis were performed by Amira-Avizo using the Despeckle, Deblur, Median Filter, Non-local Means Filter, Unsharp Mask, and Delineate modules for data sharpening and filtration provided by the software.

The 3-electrode half-cell CV characterization was performed on a cell according to an example embodiment of the disclosed technology assembled with the printed electrodes as the working electrode, a platinum foil as the counter electrode, Zn metal foil as the reference electrode, and 2 pieces of KOH-PVA hydrogel as the electrolyte. The 3-electrode full-cell CV characterization was performed between 1.35 V to 2 Von a cell according to an example embodiment of the disclosed technology assembled with an extra Zn metal foil as the reference electrode. The structures of both cells are illustrated in FIGS. 10A and 10B. The CV was performed using an Autolab PGSTAT128Npotentiostat/galvanostat with an additional pX-1000 module. In the 3-electrode full-cell CV, the AgO cathode was connected to the working electrode probe, the Zn anode was connected to the counter and reference electrode probes, and the pX-1000 module was used to monitor the potential between the cathode and the reference Zn foil. The potential of the anode vs. Zn was obtained by subtracting the cathode vs. Zn potential from the full cell potential. A scan rate of 10 mV/s was used for all CV tests.

The constant current complete discharge of a battery according to an example embodiment of the disclosed technology for primary applications was performed with the following procedure. Firstly, the assembled and vacuum-sealed battery was left idle for 1 hour to allow the electrolyte to fully permeate through the electrodes. Then, the battery was discharged using a battery test system (Landt Instruments CT2001A) at the desired current, until reaching the lower cut-off voltage of 1.35 V.

To enable the secondary application of the battery, cycling protocols were established that rely on the accurate control of the potential and DOD of the battery. To perform charge-discharge cycling on a fabricated battery, 50% of its maximum capacity, which was estimated by the low-current complete discharges, was first determined as the cyclable capacity and the basis to determine C-rates of the protocol. The battery was firstly discharged at the C-rate of 0.1C from 100% to 40% DOD. Then, the battery was recharged at the C-rate of 0.2C until reaching 2V, and then at 2V until reaching 90% DOD or C-rate of 0.05C. The battery could be then discharged and recharged at the desired C-rates between 1.35 V and 2 V, with the DOD maintained between 40% and 90% of its maximum value. Unless specified otherwise, all cycling data were performed using cells with 1×1 cm² form factor with 2 layers of active electrode materials. Example cycling data for two cells with 8-layer electrode thickness connected in series is shown in FIG. 17.

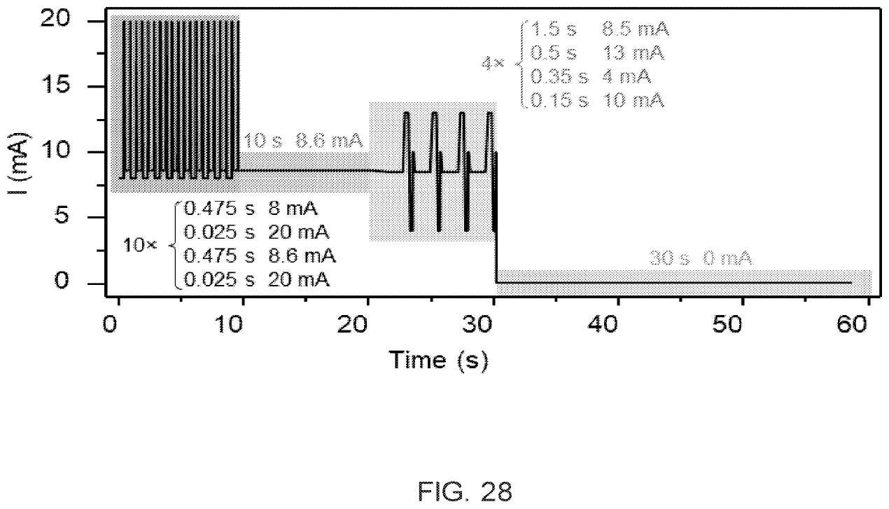

FIG. 28 shows details of the pulsed discharge profile. A pulsed discharge protocol was designed to simulate the battery's performance in powering a typical MCU-controlled wearable device with integrated BT functionality. The battery was discharged using an Autolab PGSTAT128N potentiostat/galvanostat implementing fast chrono methods.

Electrochemical Impedance Spectroscopy (EIS) measurements were performed with a Biologic SP-150 in a 3-electrode configuration. The Zn—AgO three electrodes cell according to an example embodiment of the disclosed technology was fabricated with a Zn reference wire placed between an extra layer of hydrogel electrolyte and the original electrolyte layer, as, e.g., shown in FIG. 10B. The Zn reference wire was then connected to an Au sputtered heat-sealable SEBS-based printed carbon tab that was vacuum sealed to ensure complete cell sealing to hinder electrolyte dehydration. The working electrode (WE) and counter electrode (CE) were connected to the AgO cathode and Zn anode, respectively.

The impedances of the two half cells and the full cell were monitored in-situ during charging and discharging to analyze impedance changes most closely related to practical cycling conditions with a galvanostatic-EIS (GEIS) measurement. Accordingly, the DC base current was set to the current of the charging/discharging step, while the AC amplitude was set to 300 μA, approximately one-fifth of the cycling current. The frequency sweep was between 1 MHz and 1 Hz with 10 points per decade and an average of 8 measures per frequency. The cycling script implemented with GEIS is similar to that of the capacity-limited electrochemical cycling protocol, with the exception that the voltage limits applied were 1.95 V and 1.4 V vs. the reference instead of the anode for the charging and discharging respectfully. For each charge and discharge step, 10 GEIS was measured for 15 complete cycles, resulting in a total of 870 separate Nyquist plots (29 steps×10 measures×3 cell configurations). For analysis simplicity, only the 5^{th} cycle's discharge and charge were analyzed.

Both half-cell Nyquist plots for the 5^{th} cycle's discharge and charge steps were fitted to equivalent circuits using a slightly modified version of the Zfit function available as open-source code from Mathworks. Zfit utilizes another Mathworks open source code, fminsearchbnd, to minimize the error of simulated impedances with the experimental values by altering the impedance parameters (e.g., resistance values, constant phase element values, etc.) under realistic parameter boundary conditions. The use of this code allowed for streamline fitting of many successive Nyquist to provide insights in observable trends in the fitted parameters. Additional data of the EIS measurement can be found in FIGS. 12, 18, and 19.

The ionic conductivity of the gel electrolyte was measured by a customized two-electrode (Stainless Steel 316L) conductivity cell with an inner impedance at 0.54Ω. The cell constant is frequently calibrated by using OAKTON standard conductivity solutions at 0.447, 1.5, 15, and 80 mS·cm⁻¹ respectively. A constant thickness spacer was positioned between the two electrodes which ensure no distance changes during multiple-time measurements. The electrolytic conductivity value was obtained with a floating AC signal at a frequency determined by the phase angle minima given by Electrochemical Impedance Spectroscopy (EIS) using the following equation: σ=KR^{-Q}, where R is the tested impedance (Ω), K is the cell constant (cm⁻¹) and Q is the fitting parameter. All of data acquisition and output were done by LabView Software, which was also used to control an ESPEC BTX-475 programming temperature chamber to maintain the cell at a set temperature in 30 minutes intervals.

The bending deformation of the battery was conducted by bending a 1×5 cm² battery around a cylinder with the diameter of 1 cm manually. The deformation was cycled between the bent and relaxed state at the rate of 1 s/cycle for 100 cycles. Similarly, the twisting deformation of the battery was performed manually at 1 s/cycle by fixing one end of the battery and twisting the other end 180° clockwise and counterclockwise for 100 cycles.

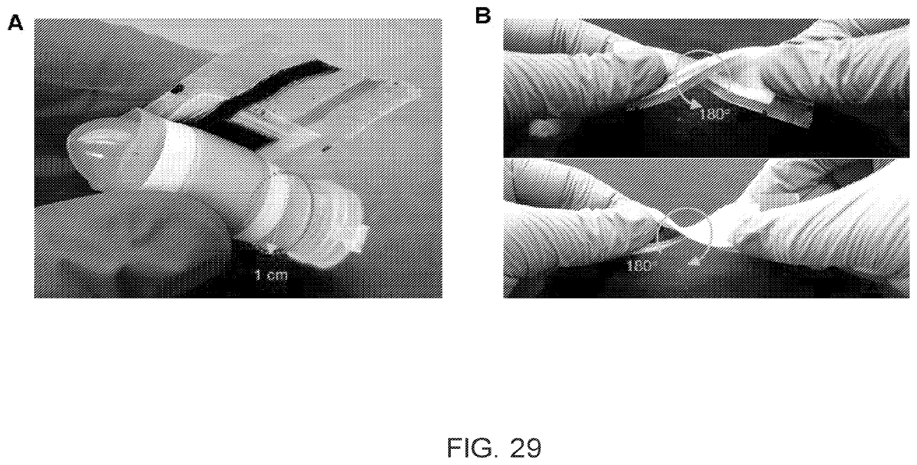

FIG. 29 shows example images illustrating the manual bending and twisting of the battery. Panel (A) in FIG. 29 shows a tube with diameter of 1 cm that was used to bend the battery for half and one entire round. Panel (B) in FIG. 29 shows an example of a battery according to an example embodiment of the technology disclosed herein twisted counterclockwise and clockwise 180° which add up to a total of 360°.

To demonstrate the battery's ability to power flexible electronics, a Waveshare 2.9-inch e-Paper flexible display was powered by two Zn—AgO batteries according to the disclosed technology in series. The display module was connected to an Adafruit Feather nRF52Bluefruit Low Energy (LE) chip and programmed using Arduino and C.

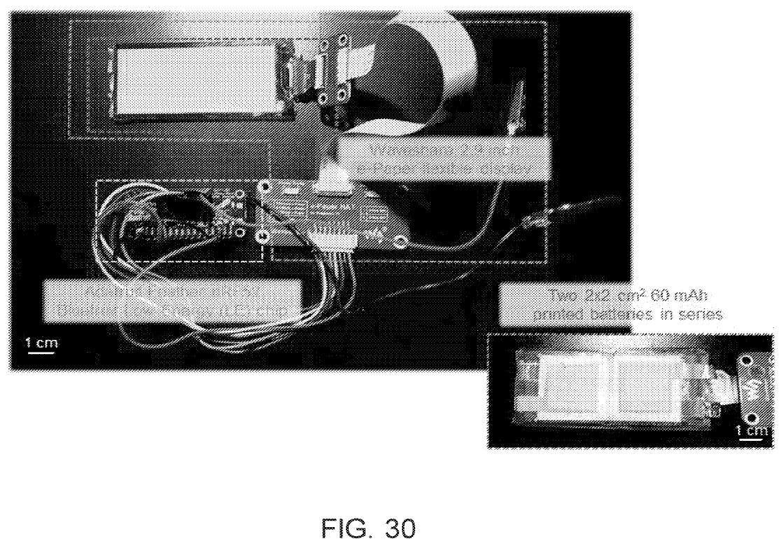

FIG. 30 shows a picture of the example assembled system. MATLAB code was used to convert images to hexadecimal format to be uploaded to the board and the display. The BluefruitConnect IOS app was used to connect the Adafruit chip via Bluetooth to change the displayed information. The system diagram of the E-ink display system is shown in FIG. 23. The pulsed current profile needed to power the Bluetooth chip and display was determined using an oscilloscope by measuring the voltage across a 10Ω resistor connected in series with the circuitry. A model pulsed profile was then extracted to be applied to flexible batteries for further testing.

### EXAMPLES

Several aspects of the present technology are set forth in the following examples. Although several aspects of the present technology are set forth in examples directed to compositions, composite materials, printable inks, flexible electronic devices or systems, and/or methods, any of these aspects of the present technology can similarly be set forth in examples directed to any of compositions, composite materials, printable inks, flexible electronic devices and/or systems, and/or methods in other embodiments described herein.

In some embodiments in accordance with the present technology (example 1), a chemical-resistant flexible composite for electrochemical cells includes a plurality of particles; and a polymer comprising fluorine, wherein the polymer is an elastomer, and wherein the polymer is configured to confine the plurality of particles within a structure formed by the polymer, wherein the polymer and the plurality of particles form an elastic polymer-particle composite.

Example 2 includes the composite of any of examples 1-24, wherein the polymer is a copolymer.

Example 3 includes the composite of example 2 or any of examples 1-24, wherein the copolymer is one of: a bipolymer, a terpolymer, or a quaterpolymer.

Example 4 includes the composite of example 2 or any of examples 1-24, wherein the copolymer comprises chlorine.

Example 5 includes the composite of example 2 or any of examples 1-24, wherein the copolymer comprises bromine.

Example 6 includes the composite of example 2 or any of examples 1-24, wherein the copolymer comprises iodine.

Example 7 includes the composite of any of examples 1-24, wherein the polymer is dissolvable in an organic solvent.

Example 8 includes the composite of any of examples 1-24, wherein the polymer is a copolymer including a combination of ethylene monomers fluorinated with between 0 and 4 fluorine atoms and/or propylene monomers fluorinated with between 0 and 6 fluorine atoms.

Example 9 includes the composite of any of examples 1-24, wherein monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether.

Example 10 includes the composite of any of examples 1-24, wherein the plurality of particles includes at least one of: a carbonaceous material, a metal, a metal oxide, a metal salt, metal flakes, nanoparticles, nanowires, nanorods, nanotubes, a powder, a polymer, a surfactant, a saccharide, or a saccharide derivative.

Example 11 includes the composite of any of examples 1-24, wherein particles in the plurality of particles include a coating layer of a coating material.

Example 12 includes the composite of example 11 or any of examples 1-24, wherein the coating material includes at least one of: a carbonaceous material, a metal, a metal oxide, a metal salt, a polymer, a surfactant, a saccharide, or a saccharide derivative.

Example 13 includes the composite of any of examples 10 or 12 or any of examples 1-24, wherein the carbonaceous material is one of: carbon, graphite, carbon black, activated carbon, graphene, or carbon nanotubes.

Example 14 includes the composite of any of examples 10 or 12 or any of examples 1-24, wherein the metal is one of: platinum, gold, silver, zinc, nickel, tin, iron, manganese, magnesium, aluminum, copper, bismuth, indium, lithium, sodium, lead, or titanium.

Example 15 includes the composite of any of examples 10 or 12 or any of examples 1-24, wherein the metal oxide is one of: zinc oxide, silver (I) oxide, silver (I, III) oxide, manganese (II) oxide, manganese (IV) oxide, bismuth (III) oxide, lead (II) oxide, lead (II, IV) oxide, titanium (IV) oxide, vanadium (III) oxide, vanadium (IV) oxide, vanadium (V) oxide, lithium (I) oxide, magnesium oxide, copper (I) oxide, copper (II) oxide, indium (III) oxide, tin (II) oxide, tin (IV) oxide, lead (II) oxide, iron (II) oxide, or iron (III) oxide.

Example 16 includes the composite of any of examples 10 or 12 or any of examples 1-24, wherein the metal salt is one of: a fluoride, a chloride, a bromide, an iodide, an acetate, a nitrate, a sulfate, a carbonate persulfate, a permanganate, a hydroxide, an oxyhydroxide, or a sulfonate.

Example 17 includes the composite of any of examples 10 or 12 or any of examples 1-24, wherein the polymer is one of: polyvinyl alcohol, polyacrylic acid, polyethylene oxide, polystyrene, polystyrene sulfonate, polymethacrylate, a polystyrene block copolymer, polyethylene vinyl acetate, polyurethane, polyvinylidene fluoride, tetrafluoro ethylene, polyvinylpyrrolidone, or polypropylene oxide.

Example 18 includes the composite of any of examples 10 or 12 or any of examples 1-24, wherein the surfactant is one of: sodium dodecyl sulfate, dodecyl benzene sodium sulfonate, or perfluorooctanesulfonate.

Example 19 includes the composite of any of examples 10 or 12 or any of examples 1-24, wherein the saccharide, or the saccharide derivative is one of: glucose, sucrose, cellulose, methylcellulose, maltodextrin methylcellulose, ethylcellulose, hydroxypropyl methylcellulose, or carboxymethyl cellulose.

Example 20 includes the composite of any of examples 1-24, wherein a chemical resistance of the polymer includes a resistance to: a pH above 10, a pH below 4, or a salinity above 2M.

Example 21 includes the composite of any of examples 1-24, wherein a chemical resistance of the polymer includes a resistance to: a pH above 14, a pH below 1, or a salinity above 5M.

Example 22 includes the composite of any of examples 1-24, wherein the composite is structured to be mechanically self-supporting.

Example 23 includes the composite of any of examples 1-24, wherein the composite is included in an electrochemical and/or electronic device.

Example 24 includes the composite of any of examples 1-23, wherein the electrochemical and/or electronic device is one of: a fuel cell, a supercapacitor, an electrochromic cell, an electrochemical sensor, a circuit interconnector, a transistor, a battery, a solar cell, or a touch screen.

In some embodiments in accordance with the present technology (example 25), a printable ink for chemical-resistant flexible electronics components includes a matrix including an organic solvent and a polymer comprising fluorine, wherein the polymer is dissolved in the organic solvent, and wherein the polymer is an elastomer; and a plurality of particles contained within the matrix, wherein the organic solvent is capable of vaporizing from the matrix such that the printable ink forms an elastic polymer-particle composite upon removal of at least a part of the organic solvent from the printable ink, and wherein the polymer is configured to confine the plurality of particles within the formed composite.

Example 26 includes the printable ink of any of examples 25-47, wherein the polymer

is a copolymer.

Example 27 includes the printable ink of example 26 or any of examples 25-47, wherein the copolymer is one of: a bipolymer, a terpolymer or a quaterpolymer.

Example 28 includes the printable ink of example 26 or any of examples 25-47, wherein the copolymer comprises chlorine.

Example 29 includes the printable ink of example 26 or any of examples 25-47, wherein the copolymer comprises bromine.

Example 30 includes the printable ink of example 26 or any of examples 25-47, wherein the copolymer comprises iodine.

Example 31 includes the printable ink of any of examples 25-47, wherein the organic solvent includes a ketone.

Example 32 includes the printable ink of example 31 or any of examples 25-47, wherein the ketone is one of: acetone, methyl ethyl ketone, methyl propyl ketone, methyl butyl ketone, methyl isobutyl ketone, acetophenone, or benzophenone.

Example 33 includes the printable ink of any of examples 25-47, wherein the organic solvent includes an ester.

Example 34 includes the printable ink of example 33 or any of examples 25-47, wherein the ester is one of: methyl formate, methyl acetate, ethyl acetate, ethyl propionate, isopropyl butyrate, or ethyl benzoate.

Example 35 includes the printable ink of any of examples 25-47, wherein the polymer is a copolymer including a combination of ethylene monomers fluorinated with between 0 and 4 fluorine atoms and/or propylene monomers fluorinated with between 0 and 6 fluorine atoms.

Example 36 includes the printable ink of any of examples 25-47, wherein monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether.

Example 37 includes the printable ink of any of examples 25-47, wherein the plurality of particles includes at least one of: a carbonaceous material, a metal, a metal oxide, a metal salt, metal flakes, nanoparticles, nanowires, nanorods, nanotubes, a powder, a polymer, a surfactant, a saccharide, or a saccharide derivative.

Example 38 includes the printable ink of any of examples 25-47, wherein the ink includes at least one of: a carbonaceous material, a metal, a metal oxide, a metal salt, a polymer, a surfactant, a saccharide, or a saccharide derivative.

Example 39 includes the printable ink of any of examples 37 or 38 or any of examples 25-47, wherein the carbonaceous material is one of: carbon, graphite, carbon black, activated carbon, graphene, or carbon nanotubes.

Example 40 includes the printable ink of any of examples 37 or 38 or any of examples 25-47, wherein the metal is one of: platinum, gold, silver, zinc, nickel, tin, iron, manganese, magnesium, aluminum, copper, bismuth, indium, lithium, sodium, lead, or titanium.

Example 41 includes the printable ink of any of examples 37 or 38 or any of examples 25-47, wherein the metal oxide is one of: zinc oxide, silver (I) oxide, silver (I, III) oxide, manganese (II) oxide, manganese (IV) oxide, bismuth (III) oxide, lead (II) oxide, lead (II, IV) oxide, titanium (IV) oxide, vanadium (III) oxide, vanadium (IV) oxide, vanadium (V) oxide, lithium (I) oxide, magnesium oxide, copper (I) oxide, copper (II) oxide, indium (III) oxide, tin (II) oxide, tin (IV) oxide, lead (II) oxide, iron (II) oxide, or iron (III) oxide.

Example 42 includes the printable ink of any of examples 37 or 38 or any of examples 25-47, wherein the metal salt is one of: a fluoride, a chloride, a bromide, an iodide, an acetate, a nitrate, a sulfate, a carbonate persulfate, a permanganate, a hydroxide, an oxyhydroxide, or a sulfonate.

Example 43 includes the printable ink of any of examples 37 or 38 or any of examples 25-47, wherein the polymer is one of: polyvinyl alcohol, polyacrylic acid, polyethylene oxide, polystyrene, polystyrene sulfonate, polymethacrylate, a polystyrene block copolymer, polyethylene vinyl acetate, polyurethane, polyvinylidene fluoride, tetrafluoro ethylene, polyvinylpyrrolidone, or polypropylene oxide.

Example 44 includes the printable ink of any of examples 37 or 38 or any of examples 25-47, wherein the surfactant is one of: sodium dodecyl sulfate, dodecyl benzene sodium sulfonate, or perfluorooctanesulfonate.

Example 45 includes the printable ink of any of examples 37 or 38 or any of examples 25-47, wherein the saccharide, or the saccharide derivative is one of: glucose, sucrose, cellulose, methylcellulose, maltodextrin methylcellulose, ethylcellulose, hydroxypropyl methylcellulose, or carboxymethyl cellulose.

Example 46 includes the printable ink of any of examples 25-47, wherein the ink is a printable or casting-compatible ink or slurry.

Example 47 includes the printable ink of example 46 or any of examples 25-46, wherein the ink is configured to be deposited via one of: inkjet printing, screen-printing, stencil printing, dip coating, spray coating, drop casting, 3D printing, injection molding, stamping, transfer printing, or water transfer printing.

In some embodiments in accordance with the present technology (example 48), a chemical-resistant flexible composite for electrochemical cells includes a plurality of particles; and a copolymer comprising atoms of a halogen element, wherein the copolymer is an elastomer, and wherein the copolymer is configured to confine the plurality of particles within a structure formed by the copolymer, wherein the copolymer and the plurality of particles form an elastic polymer-particle composite.

In some embodiments in accordance with the present technology (example 49), a printable ink for chemical-resistant flexible electronics components includes a matrix including an organic solvent and a copolymer comprising a halogen chemical element in its structure, wherein the copolymer is dissolved in the organic solvent, and wherein the copolymer is an elastomer; and a plurality of particles contained within the matrix, wherein the organic solvent is capable of vaporizing from the matrix such that the printable ink forms an elastic polymer-particle composite upon removal of at least a part of the organic solvent from the printable ink, and wherein the copolymer is configured to confine the plurality of particles within the formed composite.

In some embodiments in accordance with the present technology (example 50), a flexible battery includes a composite material, comprising: a plurality of particles; and a polymer comprising fluorine, wherein the polymer is an elastomer, wherein the polymer is configured to confine the plurality of particles within a structure formed by the polymer, and wherein the polymer and the plurality of particles form an elastic polymer-particle composite.

In some embodiments in accordance with the present technology (example 51), a flexible battery includes an anode, comprising a first layer of a first elastic composite material including a plurality of Zn particles and a first fluorine-containing polymer confining the plurality of Zn particles within the first layer; a cathode, comprising a second layer of a second elastic composite material including a plurality of AgO particles and a second fluorine-incorporating polymer confining the plurality of AgO particles within the second layer; and a layer of a hydrogel electrolyte disposed between the anode and the cathode.

Example 52 includes the battery of any of examples 51-58, wherein the first fluorine-containing polymer and the second fluorine-containing polymer are the same fluorine-containing polymer.

Example 53 includes the battery of any of examples 51-58, wherein the Zn particles are coated with a Bi₂O₃ powder.

Example 54 includes the battery of any of examples 51-58, comprising a layer of a first separator material disposed between the anode and the layer of the hydrogel electrolyte.

Example 55 includes the battery of any of example 54 or examples 51-58, wherein the first separator material includes TiO₂.

Example 56 includes the battery of any of examples 51-58, comprising a layer of a second separator material disposed between the cathode and the layer of the hydrogel electrolyte.

Example 57 includes the battery of example 56 or any of examples 51-58, wherein the second separator material includes cellulose.

Example 58 includes the battery of any of examples 51-58, wherein the hydrogel is a potassium hydroxide-poly(vinyl alcohol) hydrogel (KOH-PVA hydrogel).

In some embodiments in accordance with the present technology (example P1), a high pH-resistant elastomer binder includes a plurality of particles; and a polymer comprising fluorine-incorporated elastomeric copolymers that immobilize at least some of the plurality of particles and form an elastic polymer-particle composite.

Example P2 includes the binder of example P1, wherein the polymer is dissolvable in an organic solvent and capable of mixing with various types of materials to form flexible high-pH resist composite.

Example P3 includes the binder of example P2, wherein the dissolved polymer and the particles form a printable or casting-compatible ink or slurry.

Example P4 includes the binder of any of the preceding or subsequent examples P1-P8, wherein the polymer includes one or more of polyvinyl alcohol, polyacrylic acid, or polyethylene oxide.

Example P5 includes the binder of any of the preceding or subsequent examples P1-P8, wherein the fluorine-incorporated elastomeric copolymers include a combination of ethylene fluorinated with 0-4 fluorine atoms or propylene fluorinated with 0-6 fluorine atoms with a different degree of cross-linking and fluorination.

Example P6 includes the binder of any of the preceding or subsequent examples P1-P8, wherein the plurality of particles include one or more of graphite, carbon black, zinc, silver, copper, bismuth, the oxide of metals such as zinc oxide, silver (I) oxide, silver (I, III) oxide, bismuth (III) oxide, lead (II) oxide, titanium (IV) oxide, or other solid organic material powders such as cellulose, methylcellulose, and/or sucrose.

Example P7 includes the binder of any of the preceding or subsequent examples P1-P8, wherein the binder is included in a printed electrochemical and/or electronic device.

Example P8 includes the binder of any of example P7 or any of the preceding or subsequent examples P1-P7, wherein the printed electrochemical and/or electronic device includes a supercapacitor, electrochromic cell, sensor, circuit interconnection, thin-film transistor, battery, or touch screen.

An aspect of the disclosed embodiments relates to a chemical-resistant flexible composite for electrochemical cells, comprising: a plurality of particles; and a polymer comprising fluorine, wherein the polymer is an elastomer, and wherein the polymer is configured to confine the plurality of particles within a structure formed by the polymer, wherein the polymer and the plurality of particles form an elastic polymer-particle composite.

In some example embodiments of the chemical-resistant flexible composite for electrochemical cells, the polymer is a copolymer. According to some example embodiments, the copolymer is one of: a bipolymer, a terpolymer, or a quaterpolymer. In certain example embodiments, the copolymer comprises chlorine. In an example embodiment, the copolymer comprises bromine. In another example embodiment, the copolymer comprises iodine. In yet another example embodiment, the polymer is dissolvable in an organic solvent. According to certain example embodiments, the polymer is a copolymer including a combination of ethylene monomers fluorinated with between 0 and 4 fluorine atoms and/or propylene monomers fluorinated with between 0 and 6 fluorine atoms. In some example embodiments, monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether. According to some example embodiments, the plurality of particles includes at least one of: a carbonaceous material, a metal, a metal oxide, a metal salt, metal flakes, nanoparticles, nanowires, nanorods, nanotubes, a powder, a polymer, a surfactant, a saccharide, or a saccharide derivative. In certain example embodiments, particles in the plurality of particles include a coating layer of a coating material. In some example embodiments, the coating material includes at least one of: a carbonaceous material, a metal, a metal oxide, a metal salt, a polymer, a surfactant, a saccharide, or a saccharide derivative. According to certain example embodiments, the carbonaceous material is one of: carbon, graphite, carbon black, activated carbon, graphene, or carbon nanotubes. In some example embodiments, the metal is one of: platinum, gold, silver, zinc, nickel, tin, iron, manganese, magnesium, aluminum, copper, bismuth, indium, lithium, sodium, lead, or titanium. In certain example embodiments, the metal oxide is one of: zinc oxide, silver (I) oxide, silver (I, III) oxide, manganese (II) oxide, manganese (IV) oxide, bismuth (III) oxide, lead (II) oxide, lead (II, IV) oxide, titanium (IV) oxide, vanadium (III) oxide, vanadium (IV) oxide, vanadium (V) oxide, lithium (I) oxide, magnesium oxide, copper (I) oxide, copper (II) oxide, indium (III) oxide, tin (II) oxide, tin (IV) oxide, lead (II) oxide, iron (II) oxide, or iron (III) oxide. According to some example embodiments, the metal salt is one of: a fluoride, a chloride, a bromide, an iodide, an acetate, a nitrate, a sulfate, a carbonate persulfate, a permanganate, a hydroxide, an oxyhydroxide, or a sulfonate. In some example embodiments, the polymer is one of: polyvinyl alcohol, polyacrylic acid, polyethylene oxide, polystyrene, polystyrene sulfonate, polymethacrylate, a polystyrene block copolymer, polyethylene vinyl acetate, polyurethane, polyvinylidene fluoride, tetrafluoro ethylene, polyvinylpyrrolidone, or polypropylene oxide. In certain example embodiments, the surfactant is one of: sodium dodecyl sulfate, dodecyl benzene sodium sulfonate, or perfluorooctanesulfonate. According to some example embodiments, the saccharide, or the saccharide derivative is one of: glucose, sucrose, cellulose, methylcellulose, maltodextrin methylcellulose, ethylcellulose, hydroxypropyl methylcellulose, or carboxymethyl cellulose. In some example embodiments, a chemical resistance of the polymer includes a resistance to: a pH above 10, a pH below 4, or a salinity above 2M. In certain example embodiments, a chemical resistance of the polymer includes a resistance to: a pH above 14, a pH below 1, or a salinity above 5M. According to some example embodiments, the composite is structured to be mechanically self-supporting. In some example embodiments, the composite is included in an electrochemical and/or electronic device. In certain example embodiments, the electrochemical and/or electronic device is one of: a fuel cell, a supercapacitor, an electrochromic cell, an electrochemical sensor, a circuit interconnector, a transistor, a battery, a solar cell, or a touch screen.

Another aspect of the disclosed embodiments relates to a printable ink for chemical-resistant flexible electronics components, comprising: a matrix including an organic solvent and a polymer comprising fluorine, wherein the polymer is dissolved in the organic solvent, and wherein the polymer is an elastomer; and a plurality of particles contained within the matrix, wherein the organic solvent is capable of vaporizing from the matrix such that the printable ink forms an elastic polymer-particle composite upon removal of at least a part of the organic solvent from the printable ink, and wherein the polymer is configured to confine the plurality of particles within the formed composite.

In some example embodiments of the ink for chemical-resistant flexible electronics components, the polymer is a copolymer. According to some example embodiments, the copolymer is one of: a bipolymer, a terpolymer or a quaterpolymer. In an example embodiment, the copolymer comprises chlorine. In another example embodiment, the copolymer comprises bromine. In yet another example embodiment, the copolymer comprises iodine. In some example embodiments, the organic solvent includes a ketone. In certain example embodiments, the ketone is one of: acetone, methyl ethyl ketone, methyl propyl ketone, methyl butyl ketone, methyl isobutyl ketone, acetophenone, or benzophenone. According to some example embodiments, the organic solvent includes an ester. In some example embodiments, the ester is one of: methyl formate, methyl acetate, ethyl acetate, ethyl propionate, isopropyl butyrate, or ethyl benzoate. According to certain example embodiments, the polymer is a copolymer including a combination of ethylene monomers fluorinated with between 0 and 4 fluorine atoms and/or propylene monomers fluorinated with between 0 and 6 fluorine atoms. In some example embodiments, monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether. According to some example embodiments, the plurality of particles includes at least one of: a carbonaceous material, a metal, a metal oxide, a metal salt, metal flakes, nanoparticles, nanowires, nanorods, nanotubes, a powder, a polymer, a surfactant, a saccharide, or a saccharide derivative. In some example embodiments, the ink includes at least one of: a carbonaceous material, a metal, a metal oxide, a metal salt, a polymer, a surfactant, a saccharide, or a saccharide derivative. In certain example embodiments, the carbonaceous material is one of: carbon, graphite, carbon black, activated carbon, graphene, or carbon nanotubes. According to certain example embodiments, the metal is one of: platinum, gold, silver, zinc, nickel, tin, iron, manganese, magnesium, aluminum, copper, bismuth, indium, lithium, sodium, lead, or titanium. In some example embodiments, the metal oxide is one of: zinc oxide, silver (I) oxide, silver (I, III) oxide, manganese (II) oxide, manganese (IV) oxide, bismuth (III) oxide, lead (II) oxide, lead (II, IV) oxide, titanium (IV) oxide, vanadium (III) oxide, vanadium (IV) oxide, vanadium (V) oxide, lithium (I) oxide, magnesium oxide, copper (I) oxide, copper (II) oxide, indium (III) oxide, tin (II) oxide, tin (IV) oxide, lead (II) oxide, iron (II) oxide, or iron (III) oxide. According to some example embodiments, the metal salt is one of: a fluoride, a chloride, a bromide, an iodide, an acetate, a nitrate, a sulfate, a carbonate persulfate, a permanganate, a hydroxide, an oxyhydroxide, or a sulfonate. In some example embodiments, the polymer is one of: polyvinyl alcohol, polyacrylic acid, polyethylene oxide, polystyrene, polystyrene sulfonate, polymethacrylate, a polystyrene block copolymer, polyethylene vinyl acetate, polyurethane, polyvinylidene fluoride, tetrafluoro ethylene, polyvinylpyrrolidone, or polypropylene oxide. In certain example embodiments, the surfactant is one of: sodium dodecyl sulfate, dodecyl benzene sodium sulfonate, or perfluorooctanesulfonate. In some example embodiments, the saccharide, or the saccharide derivative is one of: glucose, sucrose, cellulose, methylcellulose, maltodextrin methylcellulose, ethylcellulose, hydroxypropyl methylcellulose, or carboxymethyl cellulose. According to some example embodiments, the ink is a printable or casting-compatible ink or slurry. In some example embodiments, the ink is configured to be deposited via one of: inkjet printing, screen-printing, stencil printing, dip coating, spray coating, drop casting, 3D printing, injection molding, stamping, transfer printing, or water transfer printing.

Yet another aspect of the disclosed embodiments relates to a chemical-resistant flexible composite for electrochemical cells, comprising: a plurality of particles; and a copolymer comprising atoms of a halogen element, wherein the copolymer is an elastomer, and wherein the copolymer is configured to confine the plurality of particles within a structure formed by the copolymer, wherein the copolymer and the plurality of particles form an elastic polymer-particle composite.

An aspect of the disclosed embodiments relates to a printable ink for chemical-resistant flexible electronics components, comprising: a matrix including an organic solvent and a copolymer comprising a halogen chemical element in its structure, wherein the copolymer is dissolved in the organic solvent, and wherein the copolymer is an elastomer; and a plurality of particles contained within the matrix, wherein the organic solvent is capable of vaporizing from the matrix such that the printable ink forms an elastic polymer-particle composite upon removal of at least a part of the organic solvent from the printable ink, and wherein the copolymer is configured to confine the plurality of particles within the formed composite.

Another aspect of the disclosed embodiments relates to a flexible battery, comprising a composite material, comprising: a plurality of particles; and a polymer comprising fluorine, wherein the polymer is an elastomer, wherein the polymer is configured to confine the plurality of particles within a structure formed by the polymer, and wherein the polymer and the plurality of particles form an elastic polymer-particle composite.

Yet another aspect of the disclosed embodiments relates to a flexible battery, comprising: an anode, comprising a first layer of a first elastic composite material including a plurality of Zn particles and a first fluorine-containing polymer confining the plurality of Zn particles within the first layer; a cathode, comprising a second layer of a second elastic composite material including a plurality of AgO particles and a second fluorine-incorporating polymer confining the plurality of AgO particles within the second layer; and a layer of a hydrogel electrolyte disposed between the anode and the cathode.

In some example embodiments of the flexible battery, the first fluorine-containing polymer and the second fluorine-containing polymer are the same fluorine-containing polymer. According to some example embodiments, the Zn particles are coated with a Bi₂O₃ powder. In certain example embodiments, the flexible battery includes a layer of a first separator material disposed between the anode and the layer of the hydrogel electrolyte. In some example embodiments, the first separator material includes TiO₂. According to certain example embodiments, the flexible battery includes a layer of a second separator material disposed between the cathode and the layer of the hydrogel electrolyte. In some example embodiments, the second separator material includes cellulose. According to some example embodiments, the hydrogel is a potassium hydroxide-poly(vinyl alcohol) hydrogel (KOH-PVA hydrogel).

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the singular forms“a”, “an” and “the” are intended to include the plural forms as well, unless the context clearly indicates otherwise. Additionally, the use of “or” is intended to include “and/or”, unless the context clearly indicates otherwise.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. A chemical-resistant flexible composite for electrochemical cells, comprising:
a plurality of particles; and
a polymer comprising fluorine, wherein the polymer is an elastomer, and wherein the polymer is configured to confine the plurality of particles within a structure formed by the polymer,
wherein the polymer and the plurality of particles form an elastic polymer-particle composite.

2. The composite of claim 1, wherein the polymer is a copolymer.

3. The composite of claim 2, wherein the copolymer is one of: a bipolymer, a terpolymer, or a quaterpolymer.

4. (canceled)

5. (canceled)

6. (canceled)

7. (canceled)

8. The composite of claim 1, wherein the polymer is a copolymer including a combination of ethylene monomers fluorinated with between 0 and 4 fluorine atoms and/or propylene monomers fluorinated with between 0 and 6 fluorine atoms.

9. The composite of claim 1, wherein monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether.

10. The composite of claim 1, wherein the plurality of particles includes at least one of: a carbonaceous material, a metal, a metal oxide, a metal salt, metal flakes, nanoparticles, nanowires, nanorods, nanotubes, a powder, a polymer, a surfactant, a saccharide, or a saccharide derivative.

11. (canceled)

12. (canceled

13. (canceled)

14. (canceled)

15. (canceled)

16. (canceled

17. (canceled)

18. (canceled)

19. (canceled)

20. The composite of claim 1, wherein a chemical resistance of the polymer includes a resistance to: a pH above 10, a pH below 4, or a salinity above 2M.

21. (canceled)

22. (canceled)

23. The composite of claim 1, wherein the composite is included in an electrochemical and/or electronic device.

24. (canceled)

25. A printable ink for chemical-resistant flexible electronics components, comprising:
a matrix including an organic solvent and a polymer comprising fluorine, wherein the polymer is dissolved in the organic solvent, and wherein the polymer is an elastomer; and
a plurality of particles contained within the matrix,
wherein the organic solvent is capable of vaporizing from the matrix such that the printable ink forms an elastic polymer-particle composite upon removal of at least a part of the organic solvent from the printable ink, and wherein the polymer is configured to confine the plurality of particles within the formed composite.

26. The ink of claim 25, wherein the polymer is a copolymer.

27. The ink of claim 26, wherein the copolymer is one of: a bipolymer, a terpolymer or a quaterpolymer.

28. (canceled)

29. (canceled)

30. (canceled)

31. The ink of claim 25, wherein the organic solvent includes a ketone.

32. The ink of claim 31, wherein the ketone is one of: acetone, methyl ethyl ketone, methyl propyl ketone, methyl butyl ketone, methyl isobutyl ketone, acetophenone, or benzophenone.

33. The ink of claim 25, wherein the organic solvent includes an ester.

34. (canceled)

35. The ink of claim 25, wherein the polymer is a copolymer including a combination of ethylene monomers fluorinated with between 0 and 4 fluorine atoms and/or propylene monomers fluorinated with between 0 and 6 fluorine atoms.

36. The ink of claim 25, wherein monomers of the polymer include at least one of: vinylidene fluoride, tetrafluoropropylene, tetrafluoroethylene, hexafluoropropylene, ethylene tetrafluoroethylene, chlorotrifluoroethylene, perfluoro alkoxy alkane, or perfluoromethylvinylether.

37. (canceled)

38. The ink of claim 25, wherein the ink includes at least one of: a carbonaceous material, a metal, a metal oxide, a metal salt, a polymer, a surfactant, a saccharide, or a saccharide derivative.

39. (canceled)

40. (canceled)

41. (canceled)

42. (canceled)

43. (canceled)

44. (canceled)

45. (canceled)

46. The ink of claim 25, wherein the ink is a printable or casting-compatible ink or slurry.

47. (canceled)

48. (canceled)

49. (canceled)

50. (canceled)

51. A flexible battery, comprising:
an anode, comprising a first layer of a first elastic composite material including a plurality of Zn particles and a first fluorine-containing polymer confining the plurality of Zn particles within the first layer;
a cathode, comprising a second layer of a second elastic composite material including a plurality of AgO particles and a second fluorine-incorporating polymer confining the plurality of AgO particles within the second layer; and
a layer of a hydrogel electrolyte disposed between the anode and the cathode.

52. The battery of claim 51, wherein the first fluorine-containing polymer and the second fluorine-containing polymer are the same fluorine-containing polymer.

53. The battery of claim 51, wherein the Zn particles are coated with a Bi₂O₃ powder.

54. The battery of claim 51, comprising a layer of a first separator material disposed between the anode and the layer of the hydrogel electrolyte.

55. (canceled)

56. (canceled)

57. (canceled)

58. (canceled)
